(19) United States
(12) Patent Application Publication
(10) Pub. No.: US 2022/0155597 A1
(43) Pub. Date: May 19, 2022

(54) DEVICE FOR HEAD-UP PROJECTION, AND HELMET FOR THE ARRANGEMENT OF A HEAD-UP PROJECTION DEVICE

(71) Applicant: DIGADES GMBH DIGITALES UND ANALOGES SCHALTUNGSDESIGN, Zittau (DE)

(72) Inventors: Tim BERGER, Zittau (DE); Philipp GOLIK, Zittau (DE); Woldemar NEBYLIZA, Zittau (DE); Markus KARP, Zittau (DE); Maik SCHAEFER, Zittau (DE)

(21) Appl. No.: 17/442,290

(22) PCT Filed: Mar. 26, 2020
(86) PCT No.: PCT/IB2020/000232

§ 371 Date: Sep. 23, 2021

(30) Foreign Application Priority Data
Mar. 27, 2019 (DE) 10 2019 107 959.4

(51) Int. Cl. G02B 27/01; A42B 3/04; G09G 3/3208; G09G 3/00

(52) U.S. Cl. CPC G02B 27/0172; A42B 3/042; G02B 2027/014; G09G 3/002; G09G 3/3208

(57) ABSTRACT

A heads-up projection device configured to be arranged on or in a helmet, for detecting and processing data and for reproducing the data in a virtual image within the view field of an eye of a user of the helmet. The device comprises a housing in which operating elements are arranged for detecting and processing data and/or reproducing the data in an imaged manner, and a combiner panel arranged on the housing. The housing is elongated and has a curved geometry such that the housing can be arranged substantially in the front region of the helmet above the eye(s) of the user, and the combiner panel can be positioned in front of the eye of the user. Also described is a helmet configured for arranging the heads-up projection device on or in the helmet.

The invention relates to a device for head-up projection from an image source, where at least one optical module of the device is connectable to a helmet, and a helmet for the arrangement of a head-up projection device.

Such a device is known from WO 2016/016445. By means of various mechanical fastening means, an optical module comprising a projector and an optical element fastened to the projector is fastened to a motorcycle helmet. The optical element is a transparent or semitransparent (prismatic) lens (combiner) arranged in extension of the projector in front of the eye of the helmet user, in such a way that the helmet user can look through the lens and a virtual image is projected onto the retina of the eye. Optionally, the optical module additionally has a front camera.

The control electronics of the optical module, the power supply and the means of communication with other peripheral devices (WLAN and Bluetooth communication interfaces) are contained in an external box, which e.g. is accommodated in a clothing pocket or fastened to the outside of the helmet.

A disadvantage of the device is that several non-transparent parts of the optical module (fastening means, projector with housing, front camera) are located in the user's field of view, and therefore disturbingly restrict the view, which consequently reduces the user's safety.

The proposed fastening possibilities for the device are unwieldy and impede the functioning of the helmet and helmet visor.

In addition, the optical module, fastened to a motorcycle helmet without a visor, can lead to increased ride wind turbulence while riding, which can impair the view and also have an unfavourable effect on the retina of the eye.

The necessary control electronics have to be carried externally or laboriously fastened to the outer skin of the helmet used, which firstly restricts the possibility of use and furthermore, in the case in particular of a motorcycle helmet, negatively affects its aerodynamics.

The problem underlying the invention is to provide a head-up projection device and a helmet for the arrangement of the head-up projection device which improves safety and comfort for the user of the head-up projection device.

Furthermore, the aerodynamic properties and the versatility of the head-up projection device are to be improved.

The problem is solved by a device for head-up projection with the features of claim 1 and by a helmet with the features of claim 16.

The head-up projection device according to the invention has a housing, in which the operating means for the acquisition and processing of data and for the imaging reproduction of the data in an optical beam are arranged, and a combiner arranged on the housing, where the head-up projection device is designed in such a way that the housing is essentially arrangeable in a front region of the helmet above the user's eye(s) and the combiner is positionable in front of the user's eye.

The operating means for independent operation for the acquisition and processing of data and for the imaging reproduction of the data in an optical beam preferably comprise at least one optical module with optical elements which process the data in an imaging manner and generate an optical beam, a processor with control electronics for controlling the optical module, and a battery to supply power.

The combiner arranged on the housing is a transparent, light-transmissive plate positioned directly in front of the user's eye that serves to deflect and project the optical beam into the user's eye and ultimately causes the virtual image to appear in a field of view of the user.

The head-up projection device according to the invention has a flat, longitudinally extended housing designed with a curved geometry.

The housing is essentially designed longitudinally extended and with a curved geometry in such a way that it can be positioned in a front region (front side) of the helmet above the eye/eyes of the user of the helmet (helmet user), without impeding the use of the helmet, impairing the wearing characteristics or safety characteristics of the helmet, or obscuring the field of view of the eye/eyes of the helmet user.

With such a design and arrangement on or in the helmet, the housing can also be positioned in a narrow area above the user's eyes (in the forehead region of user's head) without impeding the user.

Only the combiner arranged on the housing is positioned in front of the eye in the helmet user's field of view during operation of the head-up projection device, but because of its transparent properties it does not impede the user's view.

This design and arrangement of the head-up projection device according to the invention significantly increases safety and comfort for the user of a helmet with this head-up projection device.

Furthermore, the arrangement in the forehead region or rather in the front region of the helmet is aerodynamically particularly favourable; in particular, the aerodynamic properties of the helmet are not impaired.

Preferably, the combiner is movably mounted on the housing. When the head-up projection device arranged on the helmet is not in use, the movable combiner, which is preferably flat, can be flipped away from the eye and folded flat against the housing, in such a way that it is then also located above the user's eye/eyes and therefore outside the field of view or the eye and outside the facial field of the helmet user.

The movable combiner therefore also improves accessibility in the facial field of the helmet user, e.g. to put on or take off glasses.

Since, moreover, all important operating means can be integrated in the housing, and do not have to be accommodated in external assemblies, in addition a compactness is achieved which has a very favourable impact on the versatility of the head-up projection device.

The curved geometry of the housing has in its curvature a radius or several different radii which are designed to match a radius or several different radii of a helmet shell, a helmet peak or a helmet shield of the helmet.

With this shaping of the housing, the housing can be positioned following a contour of the front region of the helmet or its components, in such a way that the head-up projection device can be arranged comfortably and space-savingly above the eyes of the user or rather in the front region of the helmet.

The components in the front region of the helmet can be, for example, a helmet shell, a helmet peak or a helmet shield.

Helmet shell refers to the shell structure of the protective helmet, which essentially consists of at least one outer hard shell. The outer hard shell gives the protective helmet its general outer shape and consists of a hard, largely bending-resistant and impact-resistant material, such as fibre-reinforced plastic.

Depending on the type of construction, the helmet shell can have an inner hard shell in addition to the outer hard shell. The inner hard shell is essentially shaped in such a way that it lies against the outer hard shell on the inside and moreover is approximately adapted to the shape of the head of a helmet wearer.

Such an inner hard shell can serve to absorb impact energy in the event of anticipated falls of the helmet wearer, where the inner hard shell is usually designed in such a way that it consists of a medium-hard material which is correspondingly suitable for absorbing the impact energy if the helmet wearer falls, such as a firm, dense foam, and has a relatively greater thickness compared to the outer hard shell. The inner hard shell can be covered with a fabric or leather.

Inside the helmet shell, there can be an interior trim in the form of protective padding, which is designed as a padded shell or individual padded sections essentially lining the outer or rather inner hard shell and largely ergonomically adapted to the shape of the helmet wearer's head. The protective padding can be made of a soft material, such as an elastic foam, which firstly is suitable for absorbing impacts. The protective padding can additionally have a textile cover. The shape and the material of the protective padding can in addition serve to improve the wearing comfort for the helmet wearer.

The helmet peak essentially refers to a frontal extension of the helmet shell, which can serve among other things to protect the face, in particular the eyes and nose.

The helmet shield refers to a helmet element that can be attached to a protective helmet or other stable headgear (e.g. cap, hat) and is made of hard, largely bending-resistant and impact-resistant material.

By means of appropriate fastening means, the head-up projection device can be fastened to a front side of helmets of any kind, protective helmets or other helmet-like headgear.

A protective helmet refers to a helmet that is primarily intended to protect the head of the helmet wearer from impacts and may provide further protection.

According to the invention, the shape and extension of the housing formed curved in such a way allows all components (operating means) of a head-up projection device, or at least the following components, to be compactly arranged in its cavity:
optical module (optics) with optics housing
electronics with circuit board
one or more batteries to supply power.

As a result, no further attachment parts or parts to be carried—only the combiner which must necessarily be assigned directly to the eye—need to be carried outside the housing

According to an advantageous embodiment according to claim 2, the housing is designed essentially longitudinally extended in the direction of a spatial axis X and curved at least in the direction of a second spatial axis Y, and according to a further advantageous embodiment according to claim 3 can additionally be curved in the direction of a third spatial axis Z.

The orientation of the spatial axis X is determined in relation to the helmet user essentially parallel to the frontal surface of the head of the helmet user in the direction of the left front side of the helmet user.

The orientation of the spatial axis Y is determined in relation to the helmet user essentially perpendicularly to the frontal surface of the head of the helmet user in the direction towards the frontal surface.

The orientation of the spatial axis Z is determined in relation to the helmet user essentially parallelly to the frontal surface of the head of the helmet user in the direction of the crown of the user's head.

In this way, the head-up protection device is essentially designed in such a way that it is arrangeable longitudinally extended parallel to the eyes along the frontal surface of the helmet user's head, in such a way that the head-up projection device can be arranged even more comfortably and aerodynamically advantageously on or in the helmet.

According to a further advantageous embodiment, the housing is designed in several parts. That is, the housing of the head-up projection device can have two or more housing parts.

The housing preferably has a shell-shaped housing part and an essentially flat cover part.

In this way, assembly, accessibility and possibly maintenance of the operating means can be facilitated.

The multi-part nature of the housing can also be advantageous for optionally combining housing parts with different radii of curvature in adaptation to the situation on the helmet.

According to a further advantageous embodiment, the optical elements of the optical module are arranged in a separate optics housing (optics casing).

The optics casing ensures a fixed placement of the optical elements at the correct/intended distances from each other to permanently ensure a clear and precise image reproduction of the virtual image, and permanently protects the optical elements from the ingress of dust and moisture.

According to a further advantageous embodiment, the housing and/or the operating means are designed and arranged in such a way that an optical axis realised by the optical elements extends essentially in the direction of the spatial axis X.

The optical axis of the optical module extends along the optical beam generated by the optical module and essentially coincides with the spatial axis X.

For the realisation of the position of the optical axis, the housing can have, in addition to its curvature in the direction of the spatial axis Y and/or in the direction of the spatial axis Z, various bulges for receiving the optical module.

The optical module can be particularly short in its longitudinal extension.

With these designs, the optical module, despite the curved design of the housing in which it is arranged, can realise a straight optical axis and moreover in such a way that the optical beam points in or against the direction of the spatial axis X, and can be deflected at the end of the optical module approximately at right-angles (against the direction of the spatial axis Z) onto the combiner.

The design of the housing and arrangement of the optical module results in a further optimisation of the space requirements of the head-up projection device.

According to a preferred embodiment, an image source (display) is provided, which has OLEDs.

This use of OLEDs in the image source (display) is energy-saving and enables a reduction of the screen diagonal of the image source. Consequently, in a space-saving and weight-saving manner, the image source and the total installation space of the optical module can be reduced and the power source (battery) that has to be carried can be minimised.

Advantageously, the image source has multicoloured emitting OLEDs which emit light in several colours.

Displays with multicoloured emitting OLEDs which emit light in several colours offer wider application possibilities for image design means, in order for example to realise a better, differentiated perceptibility of warnings or other important information for the user that are to be emphasised (also for the user with colour deficiency).

In an alternative advantageous embodiment, an image source (display) is provided which has OLEDs that emit monochromatic light, preferably in a wavelength range of approximately 564 nm.

A monochromatic, preferably yellow light produces a particularly strong perception by the user.

Preferably the OLEDs have a luminous intensity of 12,000 cd/m² to 20,000 cd/m², particularly preferably up to 25,000 cd/m².

OLEDs with such a luminous intensity produce a very high luminance of the display, which realises a strong, low-loss optical beam in the passage through the optical elements and subsequently a virtual image of high sharpness and brightness.

A particularly advantageous embodiment comprises fastening means for the direct, detachable fastening of the housing on or in the helmet, where the fastening means have a base plate which is designed correspondingly to the geometry of the housing and is detachably connectable to the housing.

The base plate can be designed and arranged correspondingly to a housing wall or to several housing walls of the housing.

The geometry of the base plate is designed adapted to the shape of the housing wall/housing walls of the housing, with which the base plate corresponds to realise the connection.

As a result, a very space-saving and contour-conforming fastening of the head-up projection device on or in the helmet can be realised.

For the realisation of an easily handlable detachable connection between the base plate and the housing, the fastening means preferably have connecting elements of a hook-and-loop fastener connection, plug connection or magnetic connection, which are arranged on the base plate and on the housing.

Advantageously, the connecting elements are designed in such a way that an arrangement of the housing is laterally displaceable in relation to the base plate in the direction of the spatial axis X.

This enables greater flexibility of the fastening of the head-up projection device to the helmet, in particular the positioning of the housing and hence the position of the combiner in front of the user's eye can be precisely aligned so as to be able to achieve an exact virtual image.

Advantageous means for adjusting and fixing a position of the combiner—which is preferably rotatably mounted on the housing—with respect to the housing serve the easier adjustability and vibration-resistant alignment of the generated virtual image in the user's field of view.

The helmet according to the invention is designed to arrange a head-up protection device as described above on or in the helmet, preferably designed for the integrated arrangement of at least a part of the head-up projection device described above, on or in the helmet.

For example, the housing and/or—if provided for the indirect, detachable fastening of the housing on or in the helmet—a base plate can each be arranged partially integrated, e.g. in a space between a helmet shell and a protective padding.

According to an advantageous space-saving embodiment, a helmet shell of the helmet, preferably an inner hard shell of the helmet shell, has a recess A, in which the housing of the head-up projection device and/or a base plate is at least partially arrangeable.

According to a further advantageous embodiment, the recess A is designed in such a way that the integrable base plate is arrangeable essentially flush with the helmet shell and/or the base plate lines the recess A in conformity with the contour.

According to a further advantageous embodiment, the recess A and/or the integrable base plate has an indentation for an intervention to remove the housing from the recess or rather from the integrable base plate.

These and further features arising from the patent claims, the description of the example embodiments and the drawings can in each case be realised by themselves or in combination as advantageous embodiments of the invention for which protection is claimed here.

The head-up projection device (HUPD) according to the invention is explained in more detail below in various embodiments. The associated drawings show in a schematic representation in

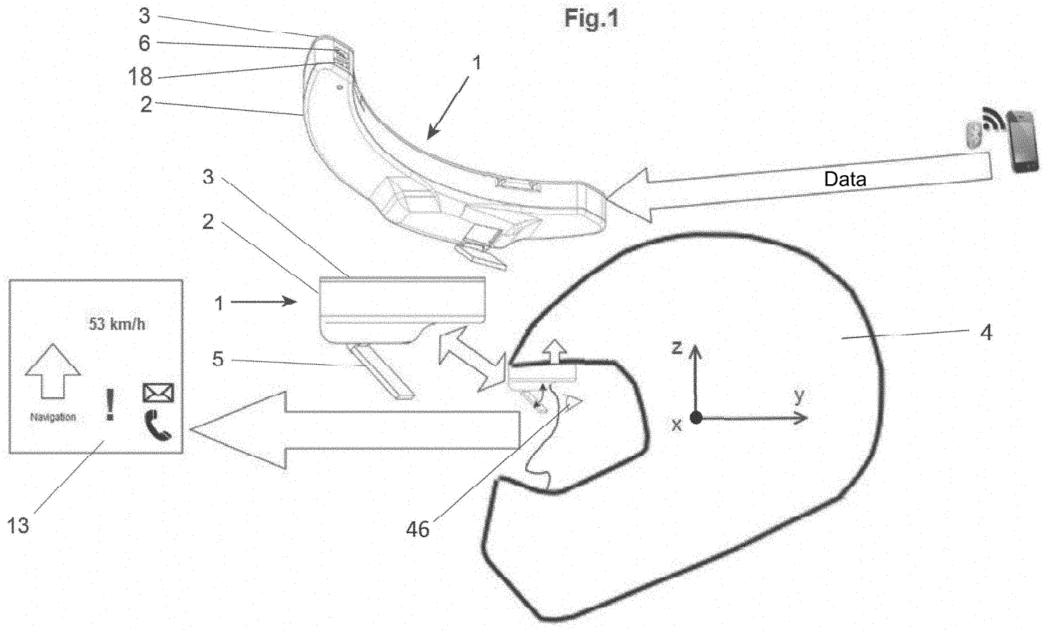

FIG. 1 an overview diagram of the basic design, functioning and arrangement of the HUPD according to the invention,

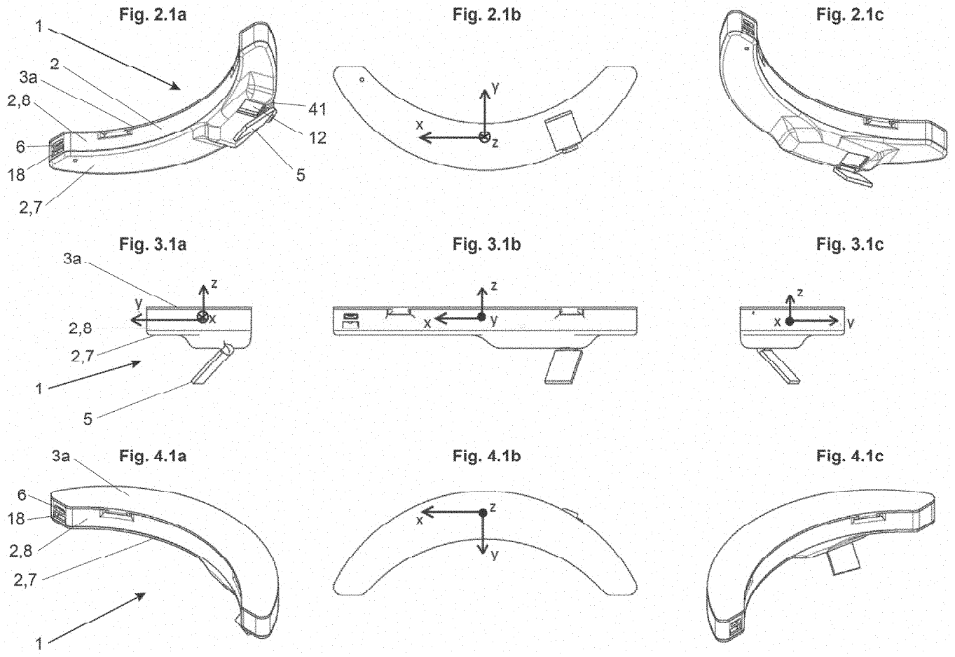

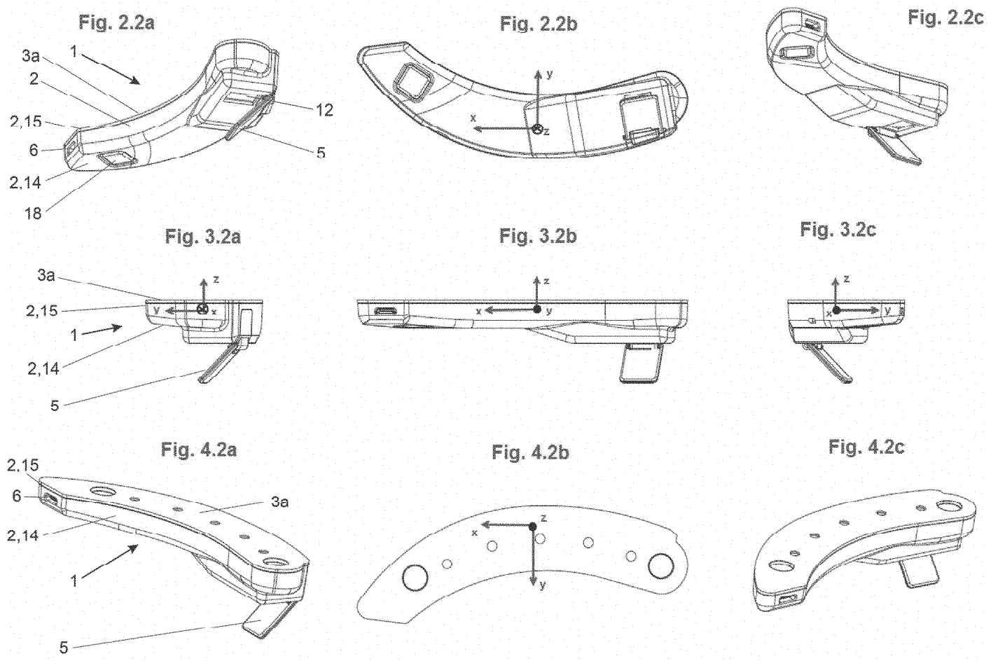

FIG. 2.1a an isometric view from below of an HUPD according to a first embodiment,

FIG. 2.1b a view of the HUPD according to FIG. 2.1a from below,

FIG. 2.1c a second isometric view of the HUPD according to FIG. 2.1a from below,

FIG. 3.1a a side view of the HUPD according to FIG. 2.1a,

FIG. 3.1b a front view of the HUPD according to FIG. 2.1a,

FIG. 3.1c a second side view of the HUPD according to FIG. 2.1a,

FIG. 4.1a an isometric view of the HUPD according to FIG. 2.1a from above,

FIG. 4.1b a top view of the HUPD according to FIG. 2.1a from above,

FIG. 4.1c a second isometric view of the HUPD according to FIG. 2.1a from above,

FIG. 2.2a an isometric view from below of an HUPD according to a second embodiment,

FIG. 2.2b a view of the HUPD according to FIG. 2.2a from below,

FIG. 2.2c a second isometric view of the HUPD according to FIG. 2.2a from below,

FIG. 3.2a a side view of the HUPD according to FIG. 2.2a,

FIG. 3.2b a front view of the HUPD according to FIG. 2.2a,

FIG. 3.2c a second side view of the HUPD according to FIG. 2.2a,

FIG. 4.2a an isometric view of the HUPD according to FIG. 2.2a from above,

FIG. 4.2b a top view of the HUPD according to FIG. 2.2a from above,

FIG. 4.2c a second isometric view of the HUPD according to FIG. 2.2a from above,

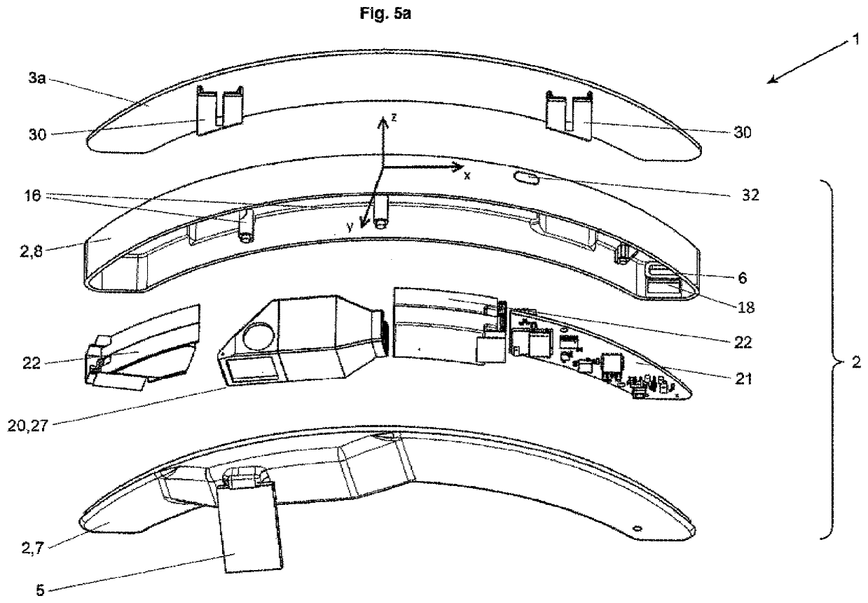

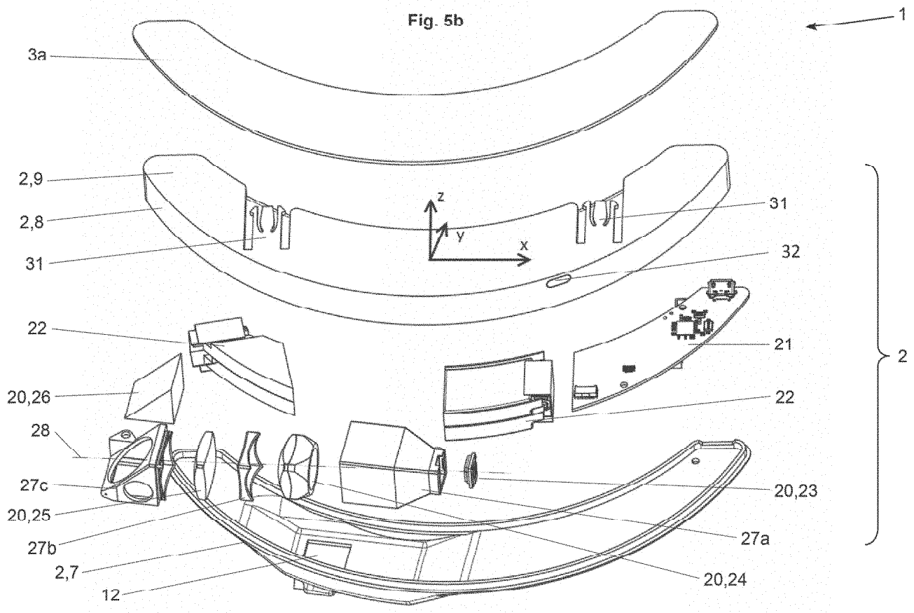

FIG. 5a an exploded view of the HUPD in the first embodiment according to FIG. 2.1a,

FIG. 5b a second exploded view of the HUPD according to FIG. 2.1a;

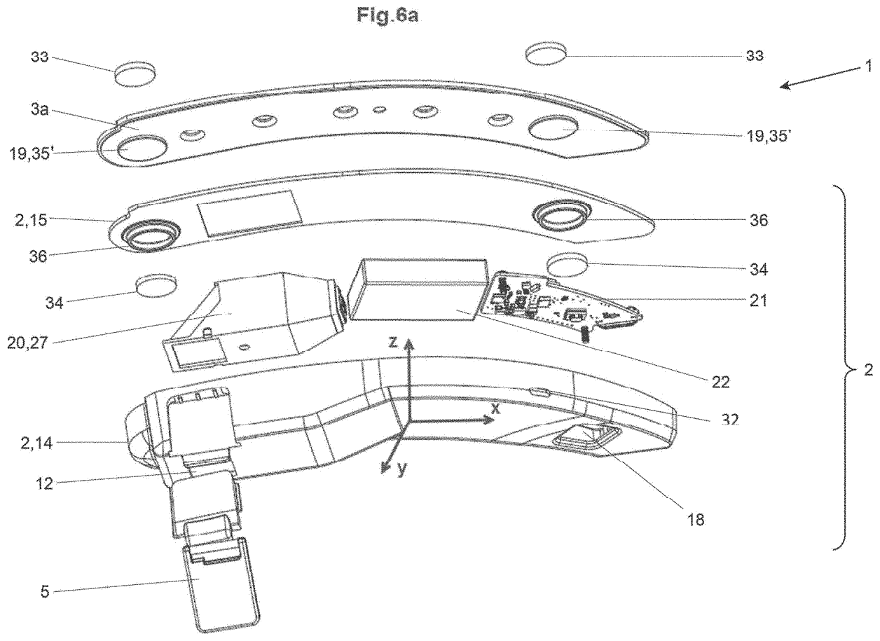

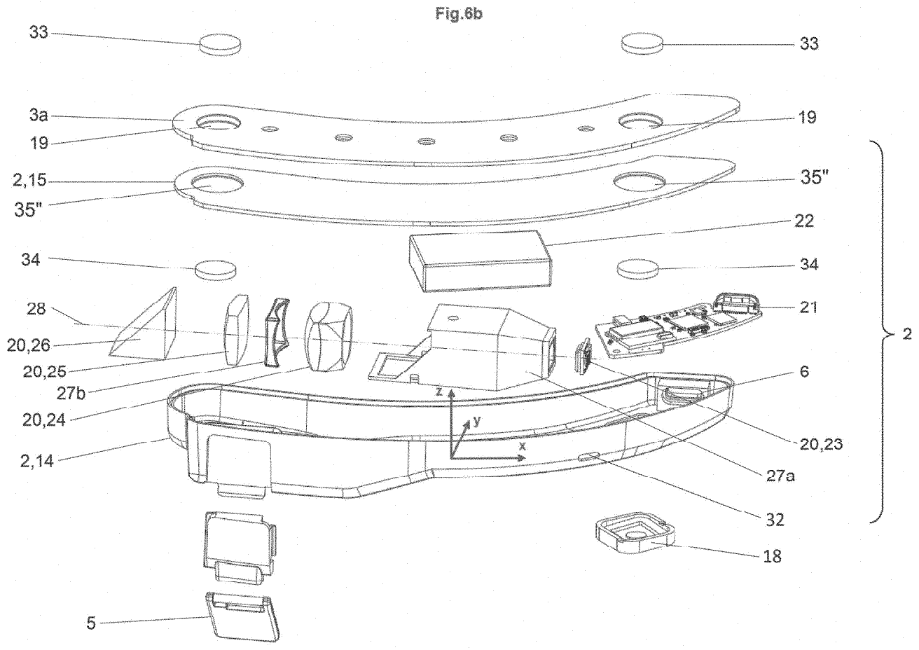

FIG. 6a an exploded view of the HUPD in the second embodiment according to FIG. 2.2a,

FIG. 6b a second exploded view of the HUPD according to FIG. 2.2a;

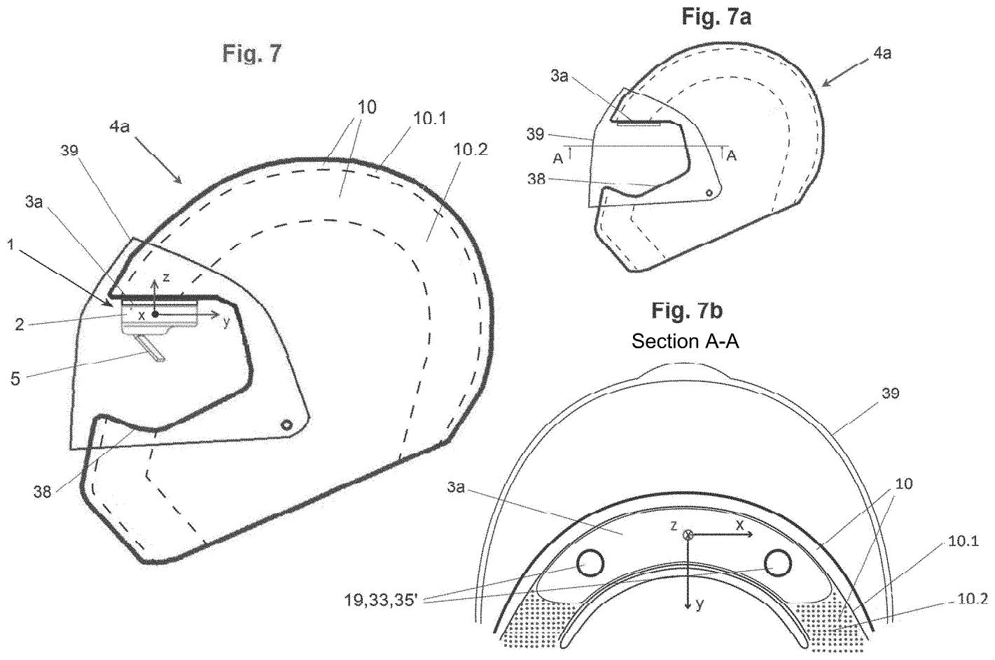

FIG. 7 a side view of a full face motorcycle helmet in a first variant of the arrangement of the HUPD,

FIG. 7a a side view of the full face motorcycle helmet according to FIG. 7 with the base plate (without housing of the HUPD),

FIG. 7b sectional view A-A of the full face motorcycle helmet according to FIG. 7a,

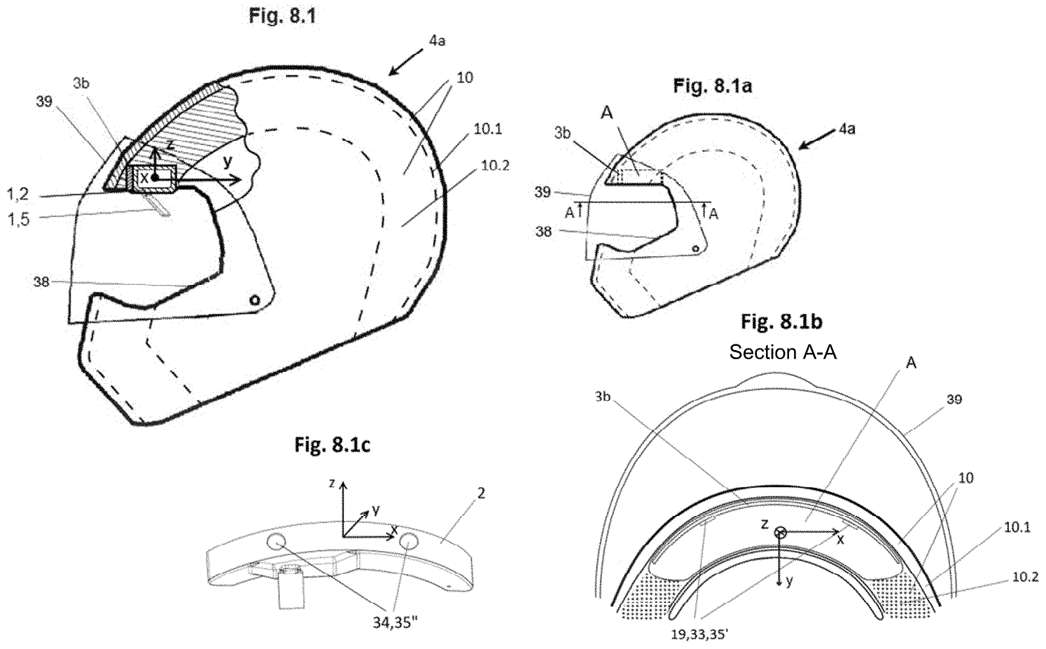

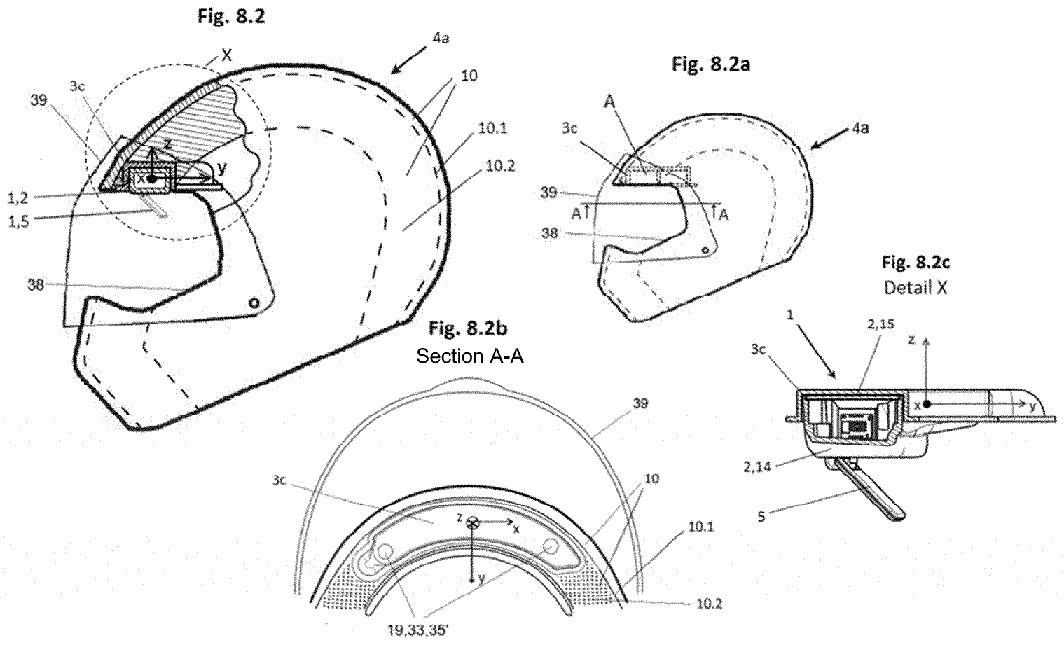

FIG. 8.1 a side view of the full face motorcycle helmet with partial cutaway in a second variant of the arrangement of the HUPD,

FIG. 8.1a a side view of the full face motorcycle helmet according to FIG. 8.1 with the base plate (without housing of the HUPD),

FIG. 8.1b sectional view A-A of the full face motorcycle helmet according to FIG. 8.1a,

FIG. 8.1c isometric view of the housing of the HUPD according to FIG. 8.1,

FIG. 8.2 a side view of a full face motorcycle helmet with partial cutaway in a third variant of the arrangement of the HUPD,

FIG. 8.2a a side view of the full face motorcycle helmet according to FIG. 8.2 with the base plate (without housing of the HUPD),

FIG. 8.2b sectional view A-A of the full face motorcycle helmet according to FIG. 8.2,

FIG. 8.2c detail X of the HUPD according to FIG. 8.2,

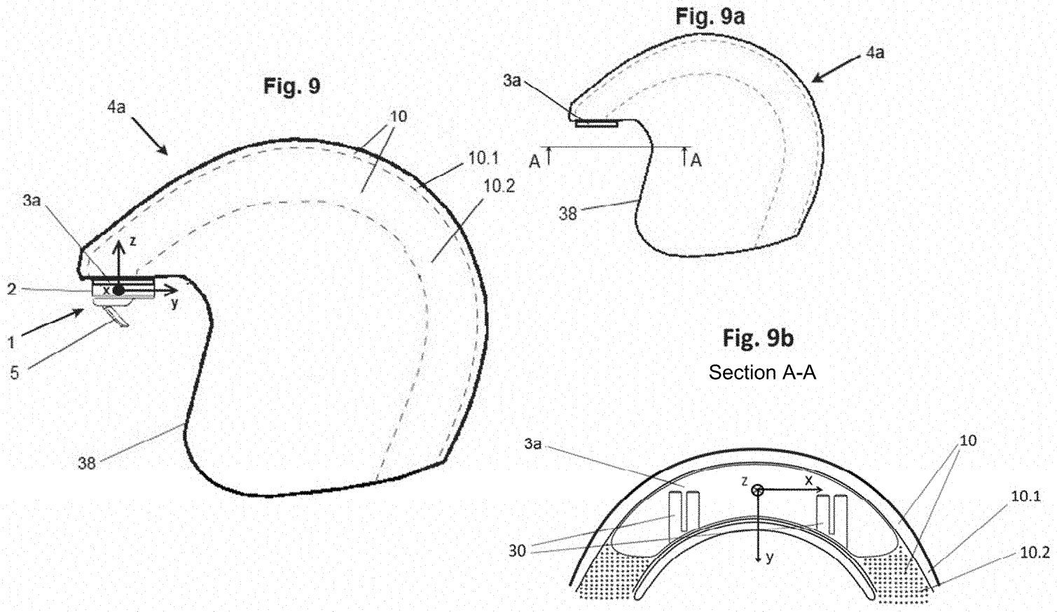

FIG. 9 a side view of a motorcycle jet helmet in a first variant of the arrangement of the HUPD,

FIG. 9a a side view of the motorcycle jet helmet according to FIG. 9 with the base plate (without housing of the HUPD),

FIG. 9b a sectional view A-A of the motorcycle jet helmet according to FIG. 9a,

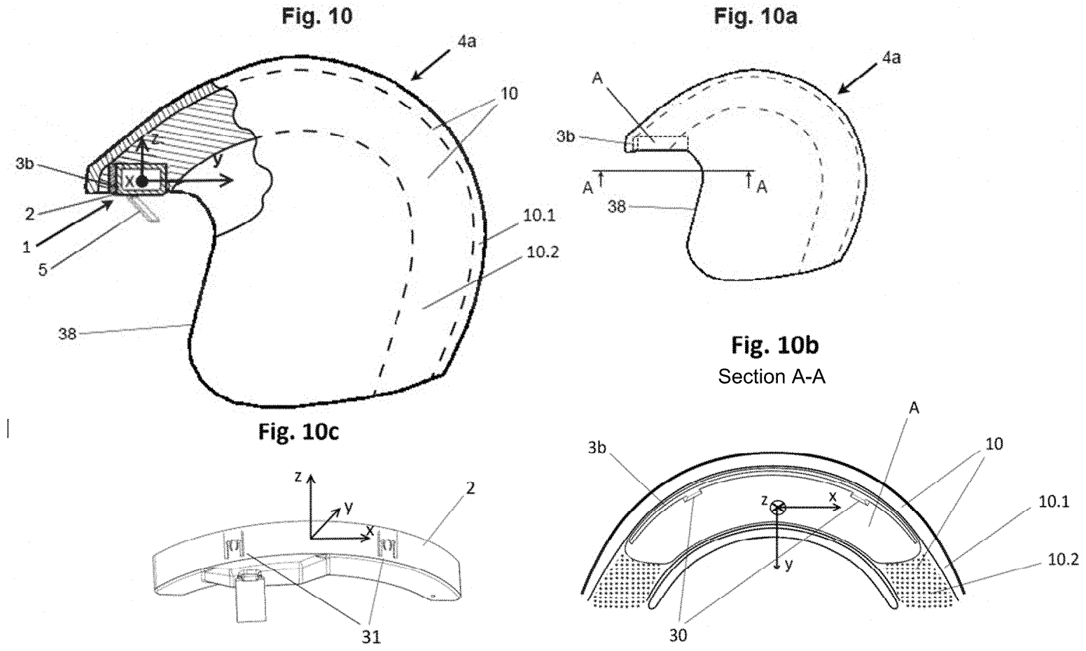

FIG. 10 a side view of a motorcycle jet helmet with partial cutaway in a second variant of the arrangement of the HUPD,

FIG. 10a a side view of the motorcycle jet helmet according to FIG. 10 with the base plate (without housing of the HUPD),

FIG. 10b a sectional view A-A of the motorcycle jet helmet according to FIG. 10a

FIG. 10c isometric view of the housing of the HUPD according to FIG. 10,

FIG. 11 a side view of a bicycle helmet with HUPD,

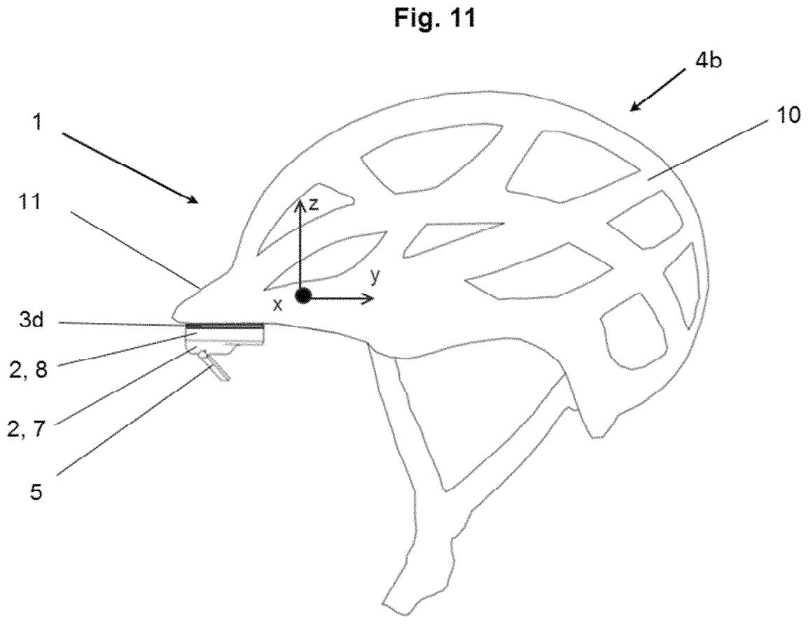

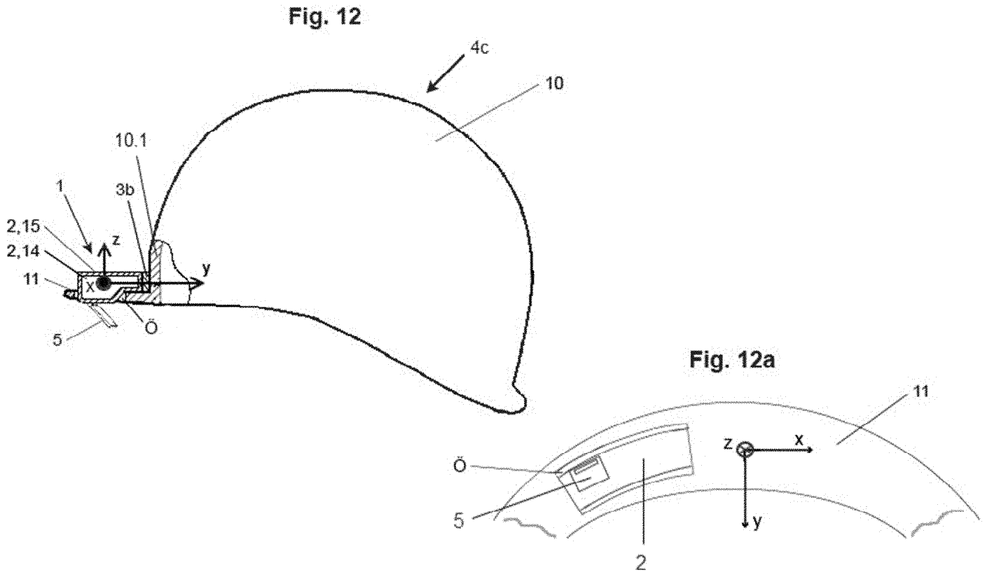

FIG. 12 a side view of an industrial safety helmet with partial cutaway with an arrangement of an HUPD,

FIG. 12a a section of the view from below of the helmet peak of the industrial safety helmet according to FIG. 12,

FIG. 13 a sectional isometric view of the HUPD according to FIGS. 5a, b with a first embodiment of the fastening and adjusting mechanism of the combiner,

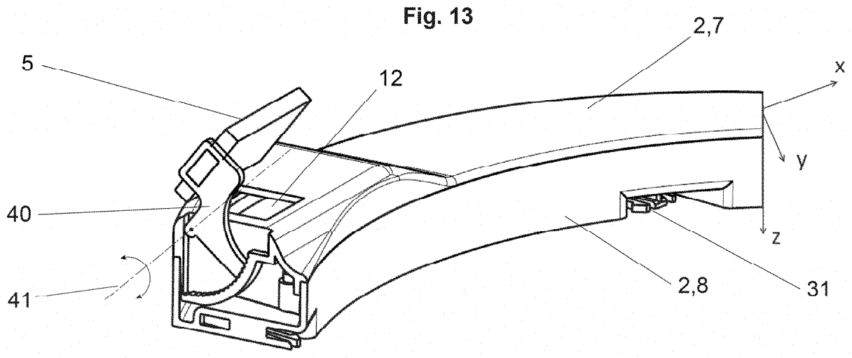

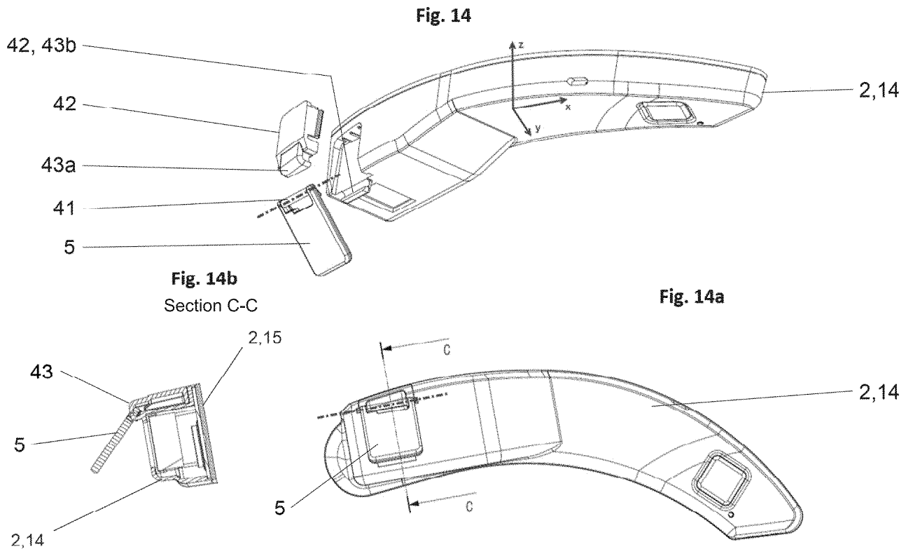

FIG. 14 an isometric view of the HUPD according to FIGS. 6a, b with a second embodiment of the fastening and adjusting mechanism of the combiner in exploded view,

FIG. 14a a view of the HUPD according to FIG. 14 from below,

FIG. 14b a sectional view of the HUPD according to FIG. 14,

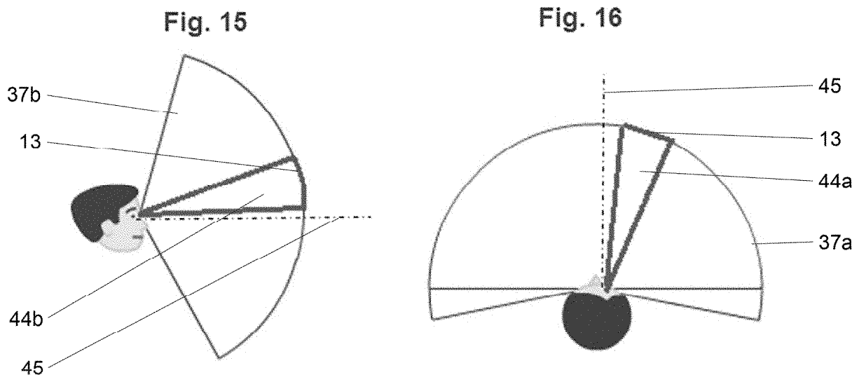

FIG. 15 schematic representation of a vertical field of view of the user with vertical image sector of the HUPD,

FIG. 16 schematic representation of a horizontal field of view of the user with horizontal image sector of the HUPD,

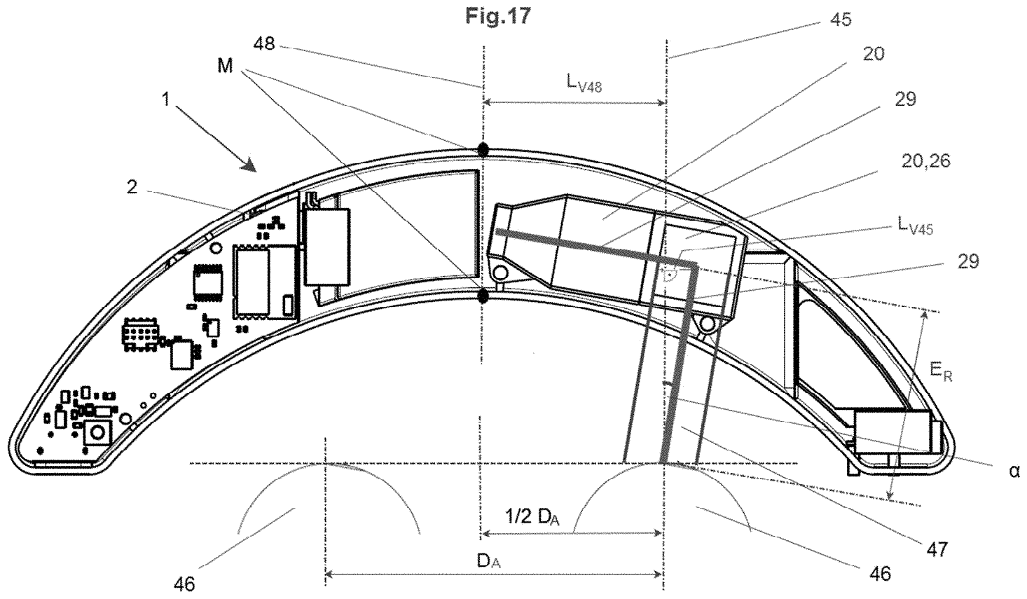

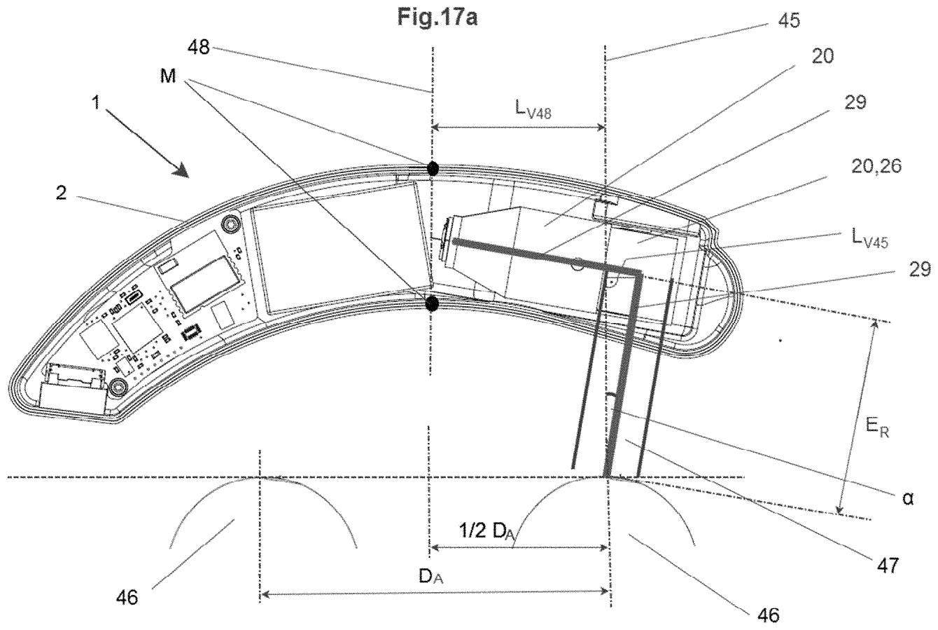

FIG. 17 a schematic representation of the arrangement of the optical module in the housing of the HUPD in relation to the position of the user's eyes,

FIG. 17a a schematic representation of the arrangement of the optical module in the alternative housing of the HUPD in relation to the user's eyes;

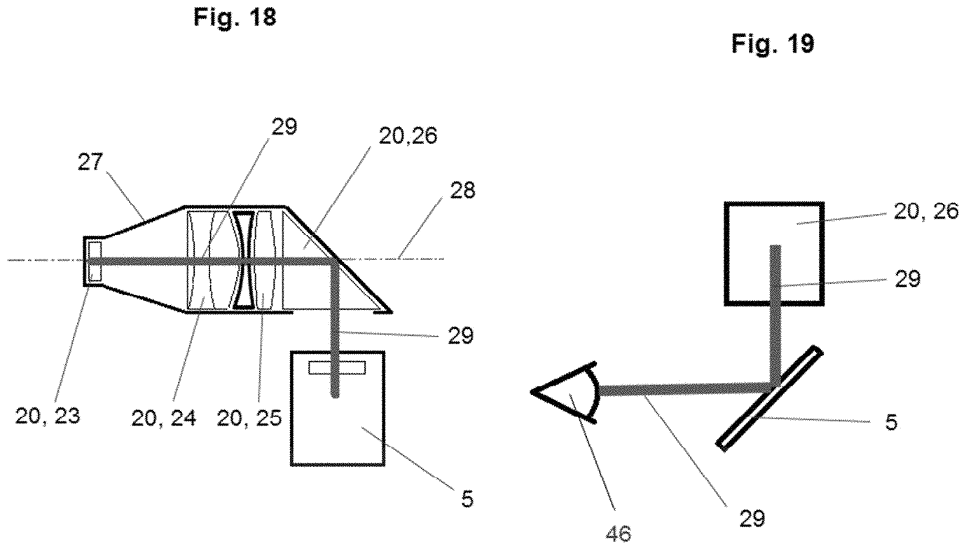

FIG. 18 a sectional view through the optical module with combiner,

FIG. 19 a side view of the optical module with combiner,

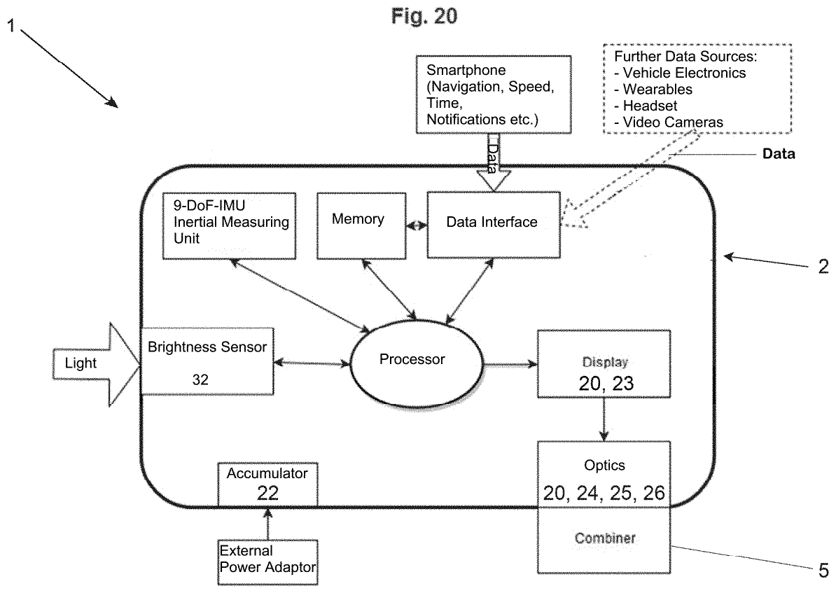

FIG. 20 a schematic block diagram of the HUPD.

In the embodiments explained below, reference is made to the accompanying drawings, which form part of the embodiment and in which specific embodiments in which the invention can be put into practice are shown for illustrative purposes.

Directional terminology contained therein, such as “top”, “bottom”, “in front”, “behind”, “forward”, “rear”, “front”, “back” etc. is used with reference to the orientation of the described figures in the illustrations, unless specified otherwise. Since components of embodiments can be positioned in a number of different orientations, the directional terminology is used for illustrative purposes and is in no way restrictive.

It is to be understood that other embodiments can be used and structural or logical changes made without departing from the protective scope of the present invention. It is further to be understood that the characteristics of the various designs described herein can be combined with each other unless specified to the contrary. The following detailed description is therefore not to be understood in a restrictive sense, and the protective scope of the present invention is defined by the appended claims.

Identical or similar elements are assigned identical reference symbols in the drawings where appropriate.

First of all, in FIG. 1 the basic design, functioning and arrangement possibility of the HUPD 1 according to the invention and the corresponding advantages are clearly illustrated.

The housing 2 of the HUPD 1 has a flat and ergonomically arced design, which is adapted to a shape of a helmet (protective helmet) 4 or rather to the shape of the user's head. This flat, ergonomically arced shape of the housing 2 enables the installation or mounting of the HUPD 1 in or on any helmet (protective helmet).

The construction according to the invention also enables a complete integration into the helmet (protective helmet) 4.

By means of a detachable fastening system (details see FIGS. 5a, b, 6a, b), the HUPD 1 can be easily fitted or removed.

The detachable fastening system of the HUPD 1 can have a base plate 3 and fastening means for the detachable connection of the housing 2 to the base plate 3. The base plate 3 can be fixedly or likewise detachably connected to the helmet (protective helmet) 4 (indirect fastening).

As a result of the construction of the housing 2 and its fastening system according to the invention, the HUPD 1 is attachable and fixable in the region of the front side of the helmet (protective helmet) 4 above the position of the user's eyes 46 and therefore largely outside the user's facial field.

Only a transparent combiner 5, which is rotatably attached to the housing 2, is placeable in the field of view 37, in order to make the desired information/data visually accessible to the user. This image data can contain e.g. information about the speed travelled, navigation, safety warnings or notifications from communication services, such as telephone and messaging services.

A special optics module 20 integrated into the housing 2 (details see FIGS. 5a, b, 6a, b) can, via the combiner 5, generate e.g. a virtual image 13 at an apparent distance of approx. 10 m from the viewer.

A mechanism for retracting the combiner 5 (details see FIGS. 13, 14) increases accessibility in the user's facial field if required, e.g. for putting on or taking off glasses.

In the housing 2 of the HUPD 1, in addition to the optics module 20, all other necessary functional elements, such as electronics module 21, battery(-ies) 22 and communication interfaces are unitedly integrated (details see FIGS. 5a, b, 6a, b).

Data can be exchanged with an external smartphone, for example, by means of wireless data transmission. Via a mains connection (power supply socket) 6, an external power supply unit for charging the battery 22/the batteries 22 can be connected. The HUPD 1 can be operated by means of a switch/push-button 18.

The housing 2 of the HUPD 1 can be designed in several parts for, among other things, the assembly of the integral components, for maintenance-friendly access to the integral components and, if necessary, for the realisation of different radii of curvature of the housing 2.

For example, the multi-part housing 2 of the HUPD 1 can have two shell-shaped housing parts (shell parts) or one shell-shaped housing part (shell part) and an essentially flat housing part as a housing cover (cover part).

FIGS. 2.1a, b, c to 4.1a, b, c show details of an exemplary multi-part housing 2 of the head-up projection device 1 according to the invention for use in conjunction with a protective helmet 4 according to a first embodiment.

FIGS. 2.1a, b, c show the housing 2 in two isometric views from below and one view from below (FIG. 2.1b)—in each case looking at an underside of the housing 2.

FIGS. 3.1a, b, c show the housing 2 in two side views and one front view, where FIG. 3.1a shows a side view of the housing 2 from the right, FIG. 3.1b a rear view of the housing 2 and FIG. 3.1c a side view of the housing 2 from the left.

FIGS. 4.1a, b, c show the housing 2 in two isometric views from above and one view from above (FIG. 4.1b)—in each case looking at an upper side of the housing 2.

The two-part housing 2 according to FIG. 2.1a, b, c to 4.1a, b, c comprises a lower, essentially flat housing part as a cover (lower cover part) 7 and an upper, shell-shaped housing part (upper shell part) 8.

The housing 2 shown in FIGS. 2.1a, b, c to 4.1a, b, which extends longitudinally in the direction of a defined spatial axis X, is narrow and curved in the direction of a defined spatial axis Y (lateral extension) relative to the longitudinal extension (uniaxially curved housing) and is very flat in the direction of a defined spatial axis Z (height extension) relative to the longitudinal extension (longitudinally extended, narrow, flat and uniaxially curved housing).

The housing 2 according to this embodiment has an approximate symmetry in its longitudinal extension (clearly shown in FIGS. 2.1b, 4.1b).

As further shown in FIGS. 1, 2.1a, b, c to 4.1a, b, c, on the underside of the housing 2 (lower cover part 7) of the HUPD 1 a locally limited bulge with an opening 12 is formed and a flat, transparent, light-transmissive combiner 5 is arranged at the opening 12 (details see FIGS. 5a, b).

The upper shell part 8 has at one end openings for the power supply socket 6 and for the switch/push-button 18 (details see FIG. 5a).

In addition to the housing 2, the HUPD 1 according to this embodiment also has a base plate 3a compatible with and corresponding in shape to the housing 2 for the indirect fastening of the HUPD 1 to the protective helmet 4.

However, the housing 2 can also be fastened to a protective helmet 4 without a base plate 3a, depending on requirements (direct fastening).

The base plate 3a according to FIG. 2.1a, b, c to 4.1a, b, c conforms in shape to an essentially flat/planar upper housing wall 9 (see FIG. 5b) of the upper shell part 8, which faces the base plate 3a and is connectable to it.

Accordingly, the corresponding base plate 3a is formed essentially flat/planar with a crescent-shaped contour—corresponding to the outer contour of the upper shell part 8 of the curved housing 2.

In the aforementioned figures, it is not shown that the housing 2 can also be formed curved with the opposite vector in the direction of the spatial axis—(minus) Y.

It is further not shown that the housing 2 can furthermore be formed curved in the direction of a spatial axis +/− (plus/minus) Z (biaxially curved housing).

The flat, longitudinally extended, narrow and curved housing 2 can be formed cross-sectionally tapered at one or both ends.

As a result, according to the embodiments shown in FIG. 1, 2.1a, b, c to 4.1a, b, c, the flat housing 2 is formed to be crescent-shaped or banana-shaped, in such a way that it can be arranged and fastened in the region of the front side/front of protective helmet 4, adapted to a curvature of the helmet shell 10 of the helmet 4 and/or to a curvature of the helmet peak 11 of the helmet 4 and/or to a curvature of a helmet shield, without impeding the user's field of view 37, since an HUPD 1 arranged in such a manner can be positioned above the position of the user's eyes 46 (see FIG. 1, 7 to 12, 15, 16).

The combiner 5 is movably fastened to the housing 2 by means of fastening means, at least pivotably around an axis of rotation 41, in such a way that the combiner 5 can be flipped down from the housing 2 when required and folded against the housing 2 when not in use, where in the latter case the only component located outside the housing 2 can be laid flat against the underside of the flat housing 2, thereby leaving sufficient space e.g. to put on and take off glasses.

Furthermore, the movable fastening of the combiner 5 also serves to adjust the location/position of the generated virtual image in the user's field of view 37.

FIGS. 2.2a, b, c to 4.2a, b, c show an exemplary multi-part housing 2 of the HUPD 1 according to the invention for use in conjunction with a protective helmet 4 according to a second embodiment.

FIGS. 2.2a, b, c show the housing 2 in two isometric views from below and one view from below (FIG. 2.2b)—in each case looking at an underside of the housing 2.

FIGS. 3.2a, b, c show the housing 2 in two side views and one front view, where FIG. 3.2a shows a side view of the housing 2 from the right, FIG. 3.2b a rear view of the housing 2 and FIG. 3.2c a side view of the housing 2 from the left.

FIGS. 4.2a, b, c show the housing 2 in two isometric views from above and one view from above (FIG. 4.2b)—in each case looking at an upper side of the housing 2.

To avoid repetitions, only the differences and their advantages with respect to the preceding first embodiment of the multi-part housing 2 of the HUPD 1 according to the invention as shown in FIGS. 2.2a, b, c to 4.2a, b, c are described below, and in ail other respects reference is to be made to the above description to FIGS. 2.2a, b, c to 4.2a, b, c.

Identical or similar elements are assigned identical reference symbols.

In contrast to the two-part housing 2 according to the embodiment shown in FIG. 2.1a, b, c to 4.1a, b, c, the two-part housing 2 according to FIG. 2.2a, b, c to 4.2a, b, c comprises a lower, shell-shaped housing part 14 (lower shell part 14) and an upper, essentially flat and planar housing part 15 as the cover (upper cover part 15)—see FIGS. 6a, b.

The lower shell part 14 has at one end in its lower, essentially planar housing wall a locally limited bulge with the opening 12 at which the combiner 5 is arranged (details see FIGS. 6a, b). At the same end, the lower shell part 14 additionally has a locally limited widening in the forward, front curved housing wall.

At the other end of the lower, essentially flat housing wall of the lower shell part 14, an opening is provided for the arrangement of the push-button 18 (details see FIGS. 6a, b).

The flat base plate 3a, which according to FIG. 2.2a, b, c to 4.2a, b, c is also present, conforms in shape to the upper cover part 15 facing the base plate 3a, and is connectable to it.

Accordingly, the base plate 3a of the HUPD 1 according to this embodiment is formed essentially flat/planar with a crescent-shaped contour—corresponding to the outer contour of the cover part 15 of the curved housing 2.

The base plate 3a according to FIG. 2.2a, b, c to 4.2a, b, c has two circular recesses, which are described in more detail in FIGS. 6a, 6b.

In addition, the base plate 3a has several holes for the possible detachable fastening to a helmet shell 10, a helmet peak 11 or a helmet shield by means of a screw fastening.

In further distinction to the embodiment according to FIG. 2.1a, b, c to 4.1a, b, c, the housing 2 according to FIG. 2.2a, b, c to 4.2a, b, c is furthermore formed shorter in its longitudinal extension in the direction of the spatial axis X and somewhat flatter in its lateral extension in the direction of the spatial axis Z.

Furthermore, the housing 2 according to this design is also symmetrical in its longitudinal extension.

The detailed construction of the exemplary head-up projection device 1 according to the first embodiment shown in FIG. 2.1a, b, c to 4.1a, b, c with a two-part, uniaxially curved housing 2 and a correspondingly shaped base plate 3a can be seen in the exploded view according to FIGS. 5a and 5b (FIG. 5a: individual parts of the head-up projection device 1 as viewed from below, FIG. 5b: individual parts of the head-up projection device 1 as viewed from above).

In the two-part, curved housing 2 of the HUPD 1 according to FIGS. 5a, b, at least one optical module 20, one circuit board 21 for the electronic control system and two batteries 22 are accommodated, which are arranged respectively to the right and left of the optical module 20.

The optical module 20 integrated into the housing 2 of the head-up projection device 1 comprises several optical elements; in the order of enumeration/arrangement in the optical module 20 preferably an image source (display) 23, an achromat 24, a separate convex lens 25 and a prism 26 standing at the end, which are arranged together in a multi-part optics housing 27 (optics casing 27) (see FIGS. 5a, b).

The optics casing 27 according to this design is formed e.g. in three parts from three casing elements 27a, b, c that can be plugged together, where there is one intermediate casing element 27b and two end casing elements 27a, c (FIG. 5b).

The shape of the casing elements 27a, b, c and their interaction with the optical elements 23, 24, 25, 26 to be accommodated enables a fixed placement of the optical elements 23, 24, 25, 26 at the correctly intended intervals to guarantee a precise image reproduction.

After receiving the optical elements 23, 24, 25, 26, the optics casing 27 is preferably durably and impermeably bonded with the optical elements 23, 24, 25, 26 to permanently ensure their precise placement while guaranteeing dust and moisture protection.

The optics casing 27 is arranged in the region of the bulge of the lower cover part 7 and is fixed and secured against slipping within the curved housing 2 by the bulging of the lower cover part 7 itself as well as by means of several retaining pins 16 of the upper shell part 8.

The optical elements 23, 24, 25, 26 and casing elements 27a, b, c of the optics casing 27 of the optical module 20 are designed and arranged extending a short way along the curved housing 2 of the head-up projection device 1 (along the spatial axis X) in such a way that the optical module 20, despite the housing 2 in which it is arranged being curved in the Y-direction, realises a straight optical axis 28 (see FIGS. 5a, b).

The housing parts 7, 8 of the multi-part housing 2 of the HUPD 1 according to FIGS. 5a, b are fixedly, but preferably detachably, connected to each other in the usage state of the head-up projection device 1, and preferably by means of a seal in a watertight manner.

For the fixed connection, the housing parts 7, 8 can be welded or glued together in such a way that the interior of the housing 2 is protected in a particularly dustproof and watertight manner.

For the detachable connection of the housing parts 7, 8, a screw fastening is suitable, for example. The detachable connection enables access to certain components of the HUPD 1, such as the batteries 22, for the purpose of maintenance or replacement.

The lower housing part 7 (lower cover part) of the housing 2 of the HUPD 1 according to FIGS. 5a, b has in the region of its bulge the opening 12 for the purpose of passing an optical beam 29 generated by the integrated optical module 20 along an optical path to the combiner 5 movably fastened near the opening 12 (details see 17, 18, 19).

Two openings on the side housing wall of the upper shell part 8 near the circuit board 21 of the optical module 20 serve firstly to receive the power supply socket 6 and secondly to receive the switch/push-button 18, which is provided for operating the HUPD 1, in particular for switching the controller on the circuit board 21 on and off to control the display 23 in the optical module 20.

Furthermore, the opening present in the front housing wall of the upper shell part 8 serves to receive a light and brightness sensor 32, in order to be able to detect the light rate or rather the brightness in the immediate front environment of the head-up projection device 1.

In a small opening in the lower cover part 7 near the circuit board 21, an LED is integrated which displays the charge state of the batteries 22.

Depending on the intended application and fastening requirements of the head-up projection device 1, the base plate 3a can be detachably connected to one of the side walls (housing wall) 9 of a shell-shaped housing part 8 (shell part) of the housing 2 (as e.g. in the design according to FIGS. 5a, b) or alternatively to a cover part 15 (housing cover) (as e.g. in the design according to FIGS. 6a, b).

The base plate 3a of the HUPD 1 according to FIGS. 5a, b can for example be detachably connected to the upper shell part 8 of the housing 2 by means of a pluggable connection.

According to FIGS. 5a, b, between the base plate 3a and the upper shell part 8 of the HUPD 1 such a form-fitting plug connection is provided, for example, which is formed by in each case one railed guidance 30 each in conjunction with a clip-snap fastener (snap part) (snap-in connection).

Two or more railed guidances 30 are arranged on a flat underside of the flat, crescent-shaped base plate 3a facing the shell-shaped housing part 8 (upper shell part 8) (visible in FIG. 5a) and two or more snap parts 31 are arranged on the flat housing wall 9 of the shell-shaped housing part 8 (upper shell part 8) facing the base plate 3a (visible in FIG. 5b).

Conversely, the railed guidances 30 can be arranged on the flat housing wall 9 of the shell-shaped housing part 8 (upper shell part 8) and the snap parts 31 on the flat underside of the crescent-shaped base plate 3a (not shown).

To establish the plug connection (snap-in connection), the respective snap part 31 of the upper shell part 8 slides under an initial tension sideways into the associated railed guidance 30 of the base plate 3a, where in an end position the two hook-shaped ends of the snap part 31 engage in matching mouldings of the railed guidance 30. To disengage the connection, by exerting a relatively strong tensile force on the snap part 31 via the housing 2, the two hook-shaped ends of the snap-part 31 are released from the mouldings and pressed together, in such a way that the snap part 31 can be easily pulled out along the railed guidances 30 without further ado.

Thus the housing 2 of the HUPD 1 is easily displaceable and lockable and unlockable relative to the base plate 3a of the HUPD 1 and parallel to the base plate plane.

If more than two railed guidances 30 and more than two snap parts 31 are provided for the plug connection (snap-in connection), the housing 2 of the HUPD 1 can if necessary alternatively be arranged laterally—in the direction of the spatial axis X—offset with respect to the base plate 3a, thus enabling greater flexibility of the fastening to the helmet 4, in particular to enable an even more precise positioning of the housing 2 and with it the combiner 5 in front of the user's eye 46.

The detailed construction of the exemplary HUPD 1 according to the second embodiment shown in FIG. 2.2a, b, c to 4.2a, b, c with a two-part, uniaxially curved housing 2 and a correspondingly shaped base plate 3a can be seen in the exploded view according to FIGS. 6a and 6b. (FIG. 6a: individual parts of the HUPD 1 as viewed from below, FIG. 6b: individual parts of the HUPD 1 as viewed from above).

To avoid repetitions, only the differences and their advantages with respect to the preceding embodiment of the HUPD 1 according to the invention as shown in FIGS. 5a, b are described below, and in all other respects reference is made to the above description to FIGS. 5a, b.

Identical or similar elements are assigned identical reference symbols.

In a difference to the design according to FIGS. 5a, b, the lower shell part 14 of the two-part, curved housing 2 of the HUPD 1 according to FIGS. 6a, b has on its upper rim a circumferential integrated edge, on which the upper cover part 15 rests in the closed state of the housing 2, in such a way that the cover part 15 lies flush with the rim of the lower shell part 14 (see FIG. 6b). As a result, the housing 2 can be better sealed and designed to be particularly flat.

In further distinction to the design according to FIGS. 5a, b, a single compact battery 22 is provided in the two-part, curved housing 2 of the HUPD 1 according to FIGS. 6a, b, which is arranged between the optical module 20 and the circuit board 21 and results in a space and weight saving and therefore better wearing characteristics of the HUPD 1.

In further distinction to the design according to FIGS. 5a, b, the optics casing 27 according to FIGS. 6a, b is formed in two parts, where in addition to the matching intermediate casing element 27b only one of the two end casing elements 27a is provided. The single end casing part 27a is designed longitudinally extended in such a way that it can at the same time receive and hold the prism 26 standing at the end. Thus the second end casing element 27c of the optics casing 27 (as provided in FIGS. 5a, b) can be eliminated here, which results in a further space and weight saving. Moreover, smaller assembly tolerances are achieved with fewer casing elements, with the result that the precise placement of the optical elements 23, 24, 25, 26 at the correctly intended intervals can be further simplified and the ensuring of dust and moisture protection can be improved.

Furthermore, a one-piece optics housing (one-piece optics casing) with these advantages is conceivable, which is closed on both sides respectively by the display 23 and the prism 26 standing at the end.

The optics casing 27 according to the design shown in FIGS. 6a, b is arranged in the region of the bulge and widening of the lower shell part 14 and is fixed and secured against slipping inside the curved housing 2 by the locally limited bulges of the lower, flat housing wall and the front curved housing wall of the lower shell part 14 as well as, in the closed state of the housing 2, by a locating recess in the upper cover part 15. In addition, fixing ribs in the lower shell part 14 (not shown) provide a further space saving compared to the retaining pins 16 according to FIGS. 5a, b while at the same time increasing the reliability and vibration resistance of the fixing.

The opening 12 in the bulge of the lower housing wall of the lower shell part 14 also serves to pass the optical beam 29 generated by the integrated optical module 20 along the optical path 29 to the combiner 5 movably fastened near the opening 12 (details see FIGS. 17, 18, 19).

The opening for receiving the switch/push-button 18 for the purpose of operating the HUPD 1, in particular for switching the controller on and off to control the display 23 in the optical module 20 is located in the lower housing wall of the lower shell part 14 near the circuit board 21.

The opening for receiving the light and brightness sensor 32 is enlarged in cross-sectional area and is located in the front housing wall of the lower shell part 14 in a transition region (rounding of the housing) to the bottom housing wall, in order to be able thus even better to detect the light rate or rather the brightness in the immediate front environment more independently of the installation situation of the head-up projection device 1 in or on a helmet 4.

At the same time, the opening is formed in such a way that the LED indicating the charge state of the battery 22 can also be provided there, so that the charge state can be monitored in a more visible manner.

The housing parts 14, 15 of the multi-part housing 2 of the HUPD 1 according to FIGS. 6a, b in their usage state are fixedly connected to each other in a watertight manner by means for example of a circumferential welded joint.

According to the design of the HUPD 1 according to FIGS. 6a, b, a magnetic connection is provided for the detachable connection of the flat, crescent-shaped base plate 3a to the upper, flat housing part 15 (housing cover).

For the realisation of the magnetic connection, at least one permanent magnet 33 (henceforth magnet 33) is arranged and fastened on or in the base plate 3a, and correspondingly at least one permanent magnet 34 with the oppositely directed polarity (henceforth opposing magnet 34) is arranged and fastened on or in the upper cover part 15.

Preferably two or more magnets 33 of the base plate 3a, as shown in FIGS. 6a, b, are arranged in two recesses 19 in the base plate 3a (positioning pockets 19 of the base plate 3a), where the recesses 19 on the underside of the base plate 3a facing the upper cover part 15 of the housing 2 form two or more protruding knobs 35′, which are designed to correspond to two or more recessed knob receptacles 35″ formed in the upper cover part 15, in such a way that the knobs 35′ in the connected state of the magnetic connection can engage in these knob receptacles 35″. These recessed knob receptacles 35″ in the upper cover part 15 are each designed on their underside facing the lower shell part 14 of the housing 2 with a circumferential rim 36, in which the opposing magnets 34 of the upper cover part 15 are enclosed (positioning pockets 36 of the cover part 15). Conversely, the positioning pockets 36 can be arranged on the planar underside of the crescent-shaped base plate 3a and the positioning pockets 19 can be arranged on the cover part 15 (not shown).

When the magnetic connection is established, the positioning pockets 19 of the base plate 3a can be easily centred in the positioning pockets 36 of the housing cover, where the magnets 33 of the base plate 3a are held by the opposing magnets 34 of the housing cover 15 and thus fix the base plate 3 to the housing cover 15.

Thus, in addition to an easily detachable, force-locked connection by the magnets 33, 34, a form-fitting connection is realised by the correspondingly shaped positioning pockets 19, 36 of the base plate 3a and of the housing cover 15, which make it possible to quickly and precisely adjust and fix the connection between the base plate 3a and housing 2 of the HUPD 1 in a simple manner.

If more than two positioning pockets 19 of the base plate 3a and more than two positioning pockets 36 of the cover part 15 are provided, the housing 2 of the HUPD 1 can if necessary alternatively be arranged laterally—in the direction of the spatial axis X—offset with respect to the base plate 3a, thus enabling greater flexibility of the fastening to the helmet 4, in particular to enable an even more precise positioning of the housing 2 and with it the combiner 5 in front of the user's eye 46.

To simplify the lateral displacement of the housing 2 with respect to the base plate 3a, a guide mechanism, preferably a rail system, can be provided (not shown).

The magnetic connection according to FIGS. 6a, b can also be formed between the planar, crescent-shaped base plate 3a and the planar housing wall 9 of the upper shell part 8 of the housing 2 according to FIGS. 5a, b.

Similarly, the plug connection according to FIGS. 5a, b can be formed between the planar, crescent-shaped base plate 3a and the upper cover part 15 of the housing 2 according to FIGS. 6a, b.

Alternatively, a base plate 3b of the HUPD 1 can be provided which is designed planarly curved (essentially curved in a strip shape)—corresponding to the arced outer contour of the side walls (front or rear housing wall) of a shell part 8 or 14 of the curved housing 2 of the HUPD 1 (see e.g. FIGS. 8.1, 8.1a, b, c, 10, 10a, b, c).

A detachable connection can then be formed—e.g. orthogonally to the designs shown in FIGS. 5a, b or rather FIGS. 6a, b)—between a strip-shaped base plate 3b which is curved/arced in its surface and a curved/arced housing wall, facing the base plate 3b, of the shell-shaped housing part (shell part) 8 or 14, where the curvature of the surface of the strip-shaped base plate 3b is formed equally/correspondingly curved in adaptation to the curved wail surface of the housing wall of the shell-shaped housing part (shell part) 8 or 14.

The mutually matched fastening means for the detachable connection can in this case be arranged on the curved wall surface of the housing wall of the shell-shaped housing part 8 or 14 and on the curved surface of the strip-shaped base plate 3b facing the curved wall surface of the housing wall of the shell-shaped housing part 8 or 14 (see e.g. FIGS. 8.1, 8.1a, b, c, 10, 10a, b, c).

Alternatively, furthermore, a base plate 3c of the HUPD 1 can be provided, which is essentially curved in a tray shape—corresponding to the outer contour of all housing walls of the upper shell part 8 of a uniaxially curved housing 2 or corresponding to the outer contour of all side housing walls of the lower shell part 14 and of the upper cover part 15 of a uniaxially curved housing 2 of the HUPD 1 (details see e.g. FIGS. 8.2, 8.2a, b, c).

Furthermore, a base plate 3d of the HUPD 1 can be provided, which is essentially curved in a crescent shape—corresponding to an outer contour of the housing wall 9 of the upper shell part 8 or corresponding to an outer contour of the upper cover part 15 of a biaxially curved housing 2 of the HUPD 1 (details see e.g. FIGS. 11, 12a, b, c).

The arced housing 2 of the HUPD 1 can be flexibly mounted in or on the helmet shell 10, on the helmet peak 11 or on a helmet shield by means of the detachable base plate 3a, 3b, 3c, 3d (indirect fastening).

In this case, the side of the planar or curved base plate 3a, 3b, 3c, 3d opposite to the fastening means for the detachable connection to the housing 2 of the HUPD 1 can be connected to correspondingly available corresponding planar or curved surfaces of the helmet shell 10/helmet peak 11/helmet shield, which can preferably be done via a non-detachable adhesive bond or alternatively detachably by means of e.g. a hook-and-loop fastener connection or screw fastening.

The arced housing 2 of the head-up projection device 1 can alternatively also be mounted directly—without a detachable base plate 3a, 3b, 3c, 3d—in or on the helmet shell 10, helmet peak 11 or helmet shield.

If, for example, the head-up projection device is to be mounted directly in this manner, a housing wail of the arced housing of the HUPD 1—e.g. the housing wall 9 of the upper shell part 8 of the housing 2 of the design according to FIGS. 5a, b—can be directly connected to a correspondingly available corresponding planar or curved surface of the helmet shell 10/helmet peak 11/helmet shield, which can be done for example by means of a non-detachable adhesive bond or detachably by means of hook-and-loop fastener elements.

Using the listed fastening possibilities, the head-up projection device 1 can be firmly but easily detachably and therefore replaceably fastened to a front side of any type of helmet 4, where the uniaxially or biaxially curvedly shaped housing 2 of the head-up projection device 1 is adapted to the corresponding helmet shape and therefore also ergonomically to the user's head shape and at the same time is arranged above the eyes 46 of the user. As a result, the necessary horizontal and vertical field of view 37a, b of the user (see FIGS. 15, 16) remains largely completely uncovered by housing parts, thus improving the unobstructed view and safety for the user compared to head-up devices known in the prior art.

FIGS. 7 to 12a show exemplary arrangement and fastening possibilities for the head-up projection device 1 according to the invention on motorcycle helmets 4a (e.g. full-visor full face helmets, jet helmets), on bicycle helmets 4b or on industrial safety helmets 4c.

The arrangement and fastening of the HUPD 1 according to the invention can be carried out on any type of hard-material helmets and caps, and are not limited to the examples described below.

FIGS. 7, 7a, b show the fastening of a head-up projection device 1 to a helmet shell 10 of a motorcycle helmet 4a as a full face helmet 4a full visor 39.

The helmet shell 10 in this embodiment comprises an outer hard shell 10.1 made of impact-resistant plastic and an inner hard shell 10.2 made of styrofoam. On the inside of the helmet shell 10 of the full-visor full face helmet 4a, protective padding in the form of a padded shell is integrated (not shown). The helmet shell 10 of the full-visor full face helmet 4a has a circumferentially closed viewing window 38 on the front side.

The HUPD has an essentially uniaxially curved housing 2 made of plastic with an essentially planar (flat), crescent-shaped base plate 3a made of plastic.

The shape of the housing 2 and of the base plate 3a of the HUPD 1 can be formed according to the design shown in FIG. 2.1a to 4.1c, 5a, b or 2.2a to 4.2c, FIGS. 6a, b, where the detachable connection of the housing 2 to the base plate 3a can be formed variably according to the design shown in FIGS. 5a, b or FIGS. 6a, b.

In this embodiment, the detachable connection of the housing 2 to the base plate 3a is carried out for example by means of a magnetic connection according to the description for FIGS. 6a, b. The described connecting elements of the magnetic connection (positioning pockets 19 with magnets 33, positioning pockets 36 with magnets 34) are on the one hand formed on the planar, crescent-shaped base plate 3a (see FIG. 7b) and on the other hand on the housing wall 9 of the upper shell part 8 of the housing 2 facing the base plate 3a according to FIGS. 2.1a to 4.1c, 5a, b, or on the upper cover part 15 or the housing 2 racing the base plate 3a according to FIGS. 2.2a bis 4.2c, 6a, b (see FIG. 7).

The base plate 3a is fastened to an underside of the helmet shell 10 at the front in the region of the viewing window 38 of the full-visor full face helmet 4a, e.g. by means of an adhesive bond or screw fastening.

Thus, in the mounted state, the HUPD 1 is placed in a flat and narrow manner along the upper edge of the viewing window 38 of the full-visor full face helmet 4a.

The helmet shell 10, preferably an inner hard shell (10.2) of the helmet shell 10 can in addition have a shallow recess, which is designed essentially correspondingly to the shape (contour and thickness) of the base plate 3a (not shown). As a result, the base plate 3a can be at least partially integrated within the helmet shell 10, or rather within the inner hard shell 10.2. The base plate 3a can alternatively be arranged completely in the recess, approximately flush with the helmet shell 10 or even recessed in the recess.

In this way, in the mounted state, the HUPD 1 can be placed in an even flatter and narrower manner along the upper edge of the viewing window 38 of the full-visor full face helmet 4a, because only the housing 2 or only a part of the housing 2 is placed in the viewing window 38, without impeding the functioning of the magnetic connection.

For an adjustment of the position of the HUPD 1 in the direction of the spatial axis X along the upper edge of the viewing window 38 of the full-visor full face helmet 4a, the magnetic connection between the base plate 3a and housing 2 can be laterally offset by means of several pairs (e.g. three or four pairs) of available positioning pockets 19 with magnets 33 and positioning pockets 36 with magnets 34 to enable a more precise positioning of the housing 2 and therefore of the combiner 5 in front of the user's eye 46.

The front housing wall arced in the direction of the spatial axis Y and the front edge of the base plate 3a have radii which correspond to the customary radii of the outside of the helmet shell 10 on the front side of the full-visor full face helmet 4a, and are positioned essentially flush with the course of the outside of the helmet shell 10 on the front side of the full-visor full face helmet 4a, in such a way that the visor 39 and, if present, a sun visor can be closed unimpeded.

The front housing wall arced in the direction of the spatial axis Y and the front edge of the base plate 3a can alternatively be arranged somewhat set back relative to the outside of the helmet shell 10 on the front side of the full-visor full face helmet 4a and thus be positioned essentially flush with the front course of the inner hard shell 10.2 or rather with the rear course of the outer hard shell 10.1 of the helmet shell 10 (see FIG. 7b).

The outside of the helmet shell 10 of the full-visor full face helmet 4a remains untouched in any case.

The rear housing wall arced in the direction of the axis Y and the rear edge of the base plate 3a have radii which correspond to the customary radii of the inside of the helmet shell 10, in particular to the inside of the inner hard shell 10.2 on the front side of the full-visor full face helmet 4a (see FIG. 7b).

The base plate 3a and housing 2 are furthermore designed essentially adapted to the customary thickness of the helmet shell 10 in their cross-sectional extension in the direction of the spatial axis Y. Thus, in the mounted state, the HUPD 1 essentially does not protrude beyond the inside of the helmet shell 10 (or rather the inside of the inner helmet shell 10.2) and is furthermore arranged at a sufficient distance from the user's head corresponding to the thickness of the protective padding and therefore does not directly touch the user's head.

The arrangement of the HUPD 1 at the upper edge of the viewing window 38 allows a largely unimpeded field of view 37 for the user and also enables glasses wearers to use glasses conveniently.

FIGS. 8.1, 8.1a, b, c show the fastening of a head-up projection device 1 in a recessed helmet shell 10 of a full-visor full face helmet 4a according to FIGS. 7, 7a, b in a second manner of fastening.

To avoid repetitions, only the differences and their advantages with respect to the preceding embodiment of the HUPD 1 according to the invention as shown in FIGS. 7, 7a, b are described below.

Identical or similar elements are assigned identical reference symbols.

The helmet shell 10 of the full-visor full face helmet 4a according to this embodiment has in particular in its inner hard shell 10.2 at the front and above the viewing window 38 a recess A essentially corresponding to the shape of the HUPD 1 (FIG. 8.1a). The recess A in the helmet shell 10 serves to at least partially receive the HUPD 1 inside the helmet shell 10, or rather inside the inner hard shell 10.2.

The HUPD 1 has an essentially uniaxially curved housing 2 and, in contrast to the design according to FIGS. 7, 7a, b, has a curved, essentially strip-shaped base plate 3b.

The housing 2 of the HUPD 1 can be formed according to the design shown in FIG. 2.1a to 4.1c, 5a, b or FIG. 2.2a to 4.2c, 6a, b, although here the design according to FIG. 6a has been chosen by way of example.

The curved, strip-shaped base plate 3b is formed correspondingly to a front curved housing wall, facing the base plate 3b, of the lower shell part 14 of the housing according to FIGS. 2.2a to 4.2c, 6a, b of the HUPD 1.

The curved, strip-shaped base plate 3b is arranged along the likewise curved front surface of the recess A and fastened e.g. by means of an adhesive bond or screw fastening to the recessed helmet shell 10.

In this embodiment, the detachable connection of the housing 2 of the HUPD 1 to the correspondingly curved, strip-shaped base plate 3b is also made by means of a magnetic connection according to the description for FIGS. 6a, b, but in contrast to the design shown in FIGS. 7, 7a, b the described connecting elements of the magnetic connection (positioning pockets 19 with magnets 33, positioning pockets 36 with magnets 34) are formed on the one hand on the curved plate surface of the strip-shaped base plate 3b (see FIG. 8.1b), and on the other hand on the front curved housing wall, facing the base plate 3b, of the lower shell part 14 of the housing 2 according to FIGS. 2.2a to 4.2c, 6a, b (see FIGS. 8.1b, c).

The recess A can have a finger-sized and -conforming indentation which enables an intervention to easily release the housing 2 from the recess A.

For an adjustment of the position of the HUPD 1 in the direction of the spatial axis X of the full-visor full face helmet 4a, the recess A can be formed longer than the length of the housing 2 extending in the X-direction to enable variable displaceability of the magnetic connection between base plate 3b and housing 2 for the purpose of the more precise positioning of the housing 2 and therefore of the combiner 5 in front of the user's eye 46.

In any case, the HUPD 1 in the mounted state is essentially placed outside the viewing window 38 of the full-visor full face helmet 4a. Only the flip-out combiner 5 protrudes into the viewing window 38 in the operating case of the HUPD 1.

The strip-shaped base plate 3b arced in the direction of the axis Y and the equally/correspondingly arced front housing wall of the housing 2 have radii which correspond to the radii of the correspondingly recessed helmet shell 10 (recess A of the inner hard shell 10.2 on the front side of the full-visor full face helmet 4a.

Also in this embodiment of the placement of the HUPD 1, the outside of the helmet shell 10 of the full-visor full face helmet 4a remains unaffected. In particular, the visor 39 and, if present, a sun visor can be closed unimpeded.

In particular, the protective function of the outer hard shell 10.1 of the helmet shell is also not impaired by the recess A in the inner hard shell 10.2.

The rear housing wall, arced in the direction of the axis Y, of the housing 2 has radii which essentially correspond to the customary radii of the inside of the helmet shell 10 (or rather the inside of the inner helmet shell 10.2) on the front side of the full-visor full face helmet 4a.

Base plate 3b and housing 2 are furthermore formed in their cross-sectional extension in the direction of the spatial axis Y essentially adapted to the thickness of the helmet shell 10, in particular to the thickness of the inner hard shell 10.2, in such a way that the HUPD 1 in the mounted state essentially does not protrude or only slightly protrudes beyond the inside of the helmet shell 10 (or rather the inside of the inner helmet shell 10.2). The protective padding of the full-visor full face helmet 4a covers the mounted HUPD 1—essentially without deviating in its course along the inside of the helmet shell 10.

If necessary, a recess can be provided in the protective padding to partially receive the HUPD 1.

Therefore, in this embodiment also, the head-up projection device does not directly touch the user's head, and also with this manner of implementation and manner of mounting the HUPD 1, where the protective padding covers the HUPD 1 on the rear side, the HUPD 1 does not cause any uncomfortable pressure on the user's head.

Since in this manner of implementation and manner of mounting, the HUPD 1 is arranged above the viewing window 38 of the helmet shell 10, this design allows a completely unimpeded field of view 37 for the user and furthermore enables an even more convenient use of glasses for glasses wearers.

Alternatively, it is envisaged that in the recess A of the helmet shell 10 of the full face helmet 4a, a design of the HUPD 1 according to FIGS. 7, 7a, b can be integrated, where the planar, crescent-shaped base plate 3a is arranged on and fastened to a wall delimiting the recess A in the direction of the spatial axis Z (not shown).

FIGS. 8.2, 8.2a, b, c shoal the fastening of a head-up projection device 1 in the recessed helmet shell 10 of the full-visor full face helmet 4a according to FIGS. 8.1, 8.1a, b, c in an alternative manner of fastening.

To avoid repetitions, only the differences and their advantages with respect to the preceding embodiment of the HUPD 1 according to the invention as shown in FIGS. 8.1, 8.1a, b, c are described below.

Identical or similar elements are assigned identical reference symbols.

The HUPD 1 has an essentially uniaxially curved housing 2 in accordance with the design shown in FIGS. 2.2a to 4.2c, 6a, b and in contrast to the design shown in FIGS. 8.1, 8.1a, b, c has a curved, tray-shaped base plate 3c (see detail X, FIG. 8.2c).

This tray-shaped base plate 3c is arranged accurately fittingly in the recess A of the helmet shell 10, or rather in the recess A of the inner hard shell 10.2, and fixed in e.g. by means of an adhesive bond (see FIG. 8.2a). The base plate 3c is designed in such a way that it fills the corresponding recess A of the inner hard shell 10.2 in conformity with the contour.

The tray-shaped base plate 3c can have a circumferential folded rim projecting beyond the recess A, which can be placed against the surface of the inner hard shell 10.2 in such a way that a rim surrounding the recess A is covered, and which is connectable to the outer hard shell 10.1.

The tray-shaped base plate 3c provides improved stability of the recessed helmet shell 10. It enables, on the one hand, in particular a retention of the shape of the recess in the inner hard shell 10.2 and, on the other hand, a protection of the material of the inner hard shell 10.2 in the region of the recess against premature wear due to the intended repeated detachable mounting of the housing 2 of the HUPD 1 in the full-face helmet 4a.

In the mounted state of the HUPD 1 on the full-face helmet 4a, the tray-shaped base plate 3c encloses the curved housing 2 with the shell part 14 and the cover part 15, except only for the underside of the lower shell part 14 of the housing 2 (see FIGS. 8.2, 8.2c).

The detachable connection of the housing 2 to the base plate 3c is made by means of a magnetic connection according to the description for FIGS. 6a, b, where the described connecting elements of the magnetic connection (positioning pockets 19 with magnets 33, positioning pockets 36 with magnets 34) are formed on the one hand on a substantially planar, crescent-shaped tray floor of the tray-shaped base plate 3c (see FIG. 8.2b) and on the other hand on the upper cover part 15 of the housing 2 (see FIG. 8.2c).

Thus, here too, the HUPD 1 in the mounted state is essentially placed outside the viewing window 38 of the full-visor full face helmet 4a. Only the flip-out combiner 5 protrudes into the viewing window 38 in the operating case of the HUPD 1.

A finger-sized and -conforming indentation in the tray-shaped base plate 3c enables an intervention to easily release the housing 2 from the tray-shaped base plate 3c.

For an adjustment of the position of the HUPD 1 in the direction of the spatial axis X of the full-visor full face helmet 4a, the recess A as well as the tray-shaped base plate 3c can be formed longer than the length of the housing 2 extending in the X-direction to enable variable displaceability of the magnetic connection between base plate 3c and housing 2 for the purpose of the more precise positioning of the housing 2 and therefore of the combiner 5 in front of the user's eye 46.

It is envisaged that the tray-shaped base plate 3c extending longer in the X-direction has a guide mechanism, preferably a rail system, for the variable displacement of the housing 2 within the tray-shaped base plate 3c (not shown).

FIGS. 9, 9a, b show the fastening of a head-up projection device 1 to a helmet shell 10 of a motorcycle helmet 4a as a jet helmet similar to the design shown in FIGS. 7, 7a, b.

To avoid repetitions, only the differences with respect to the fastening of the HUPD 1 according to the invention as shown in FIGS. 7, 7a, b are described below.

Identical or similar elements are assigned identical reference symbols.

In contrast to the helmet shell of the full-visor full face helmet 4a, the helmet shell 10 of the jet helmet 4a has at the front a viewing window 38 that is open at the bottom (in the chin region). On the inside of the helmet shell 10 of the jet helmet 4a, protective padding is provided (not shown).

The design of the housing 2 and of the base plate 3a of the HUPD 1 as well as their arrangement and fastening are largely analogous to the embodiment according to FIGS. 7, 7a, b, with the result that in this regard reference can be made to the description for FIGS. 7, 7a, b.

The housing 2 of the HUPD 1 can be formed according to the design shown in FIG. 2.1a to 4.1c, 5a, b or FIG. 2.2a to 4.2c, 6a, b, although here the design according to FIG. 6a has been chosen by way of example.

In contrast to the design according to FIGS. 7, 7a, b, in this embodiment the detachable connection of the housing 2 of the HUPD 1 to the corresponding planar, crescent-shaped base plate 3a is preferably made by means of a plug connection according to the description for FIGS. 5a, b, where the described connecting elements (railed guidance 30, snap part 31) are formed on the one hand on the planar, crescent-shaped base plate 3a (see FIG. 9b) and on the other hand on the housing wall 9, facing the base plate 3a, of the upper shell part 8 of the housing 2 according to FIGS. 2.1a to 4.1c, 5a, b (see FIG. 9).

This allows the housing 2 of the HUPD 1 to be moved relative to the base plate 3a of the HUPD 1 in or against the direction of the spatial axis Y for mounting or removal and to be locked and unlocked. Here the viewing window 38 of the jet helmet 4a, which is open in the chin region, enables easy access.

If more than two railed guidances 30 and more than two snap parts 31 are provided for the plug connection (snap-in connection), the housing 2 of the HUPD 1 can if necessary be arranged laterally—in the direction of the spatial axis X—offset with respect to the base plate 3a, and thus the combiner 5 can be positioned even more precisely in front of the user's eye 46.

Here too, for space optimisation, the helmet shell 10, preferably an inner hard shell (10.2) of the helmet shell 10 can have a shallow recess, which is designed essentially correspondingly to the shape (contour and thickness) of the base plate 3a (not shown). The base plate 3a can in particular be arranged completely in the recess, approximately flush with the helmet shell 10, without impairing the slide mechanism of the plug connection.

FIGS. 10, 10a, b, c show the fastening of a head-up projection device 1 to the helmet shell 10 of the jet helmet 4a according to FIGS. 9, 9a, b in a second manner of fastening.

The design of the housing 2 and of the base plate 3b of the HUPD 1 as well as their arrangement and fastening are largely implemented in combination of the embodiments according to FIGS. 8.1, 8.1a, b, c and 9, 9a, b, with the result that in this regard, reference can be made to the description for FIGS. 8.1, 8.1a, b, c and 9, 9a, b.

In contrast to the design according to FIGS. 8.1, 8.1a, b, c and 9, 9a, b, the detachable connection of the housing 2 of the HUPD 1 to a correspondingly curved, strip-shaped base plate 3b is made by means of a plug connection according to the description for FIGS. 5a, b, where the described connecting elements (railed guidance 30, snap part 31) are formed on the one hand on the curved plate surface of the base plate 3b (see FIG. 10b) and on the other hand on the curved front housing wall, facing the base plate 3b, of the upper shell part 8 of the housing 2 according to FIGS. 2.1a to 4.1c, 5a, b (see FIG. 10c).

FIG. 11 shows the fastening of a head-up projection device to a helmet peak 11 of a bicycle helmet 4b.

The helmet peak 11 is essentially biaxially arced and arranged on the front side in extension of a helmet shell 10 of the bicycle helmet 4b.

The helmet shell 10 in this embodiment comprises an outer and an inner hard shell 10.1, 10.2.

The outer hard shell 10.1 of the helmet shell 10 and of the helmet peak 11 are made of impact-resistant material, such as plastic. The inner hard shell 10.2 consists e.g. of styrofoam.

On the inside of the helmet shell 10 of the bicycle helmet 4b, a protective padding made of padding sections (not shown) is fastened. The visible closure straps are attached to the helmet shell 10 and/or to the protective padding.

The HUPD 1 envisaged here has an essentially biaxially curved housing 2 with a curved/arced and crescent-shaped base plate 3d.

The biaxially curved housing 2 of the HUPD 1 can be designed analogously to the design according to FIGS. 5a, b or FIGS. 6a, b and fastened to the base plate 3d. The following description is limited only by way of example to a design analogous to FIGS. 5a, b.

The curved, crescent-shaped base plate 3d is formed correspondingly to a housing wall 9, curved in the direction of the spatial axis Z and facing the base plate 3d, of the upper shell part 8 of the housing 2 according to FIGS. 5a, b.

The curved, crescent-shaped base plate 3d is fastened to the underside of the arced helmet peak 11 of the bicycle helmet 4b by means of e.g. an adhesive bond or screw fastening.

In this embodiment, the detachable connection of the biaxially curved housing 2 of the HUPD 1 to the correspondingly curved crescent-shaped base plate 3d is made preferably by means of a plug connection according to the description for FIGS. 5a, b, where the described connecting elements (railed guidance 30, snap part 31) are formed on the one hand on the curved plate surface of the crescent-shaped base plate 3d and on the other hand on the curved housing wall 9, facing the base plate 3d, of the upper shell part 8.

The front housing wall, arced in the direction of the spatial axis Y, of the upper shell part 8 and the upper housing wall 9, arced in the direction of the spatial axis Z, of the upper shell part 8 and the front contour of the base plate 3d, which is equally/correspondingly arced in the direction of the axis Z, preferably have radii that correspond to the customary radii of the helmet peak 11 of the bicycle helmet 4b, in such a way that the HUPD 1 essentially lies flush on the underside of the helmet peak 11 and does not protrude beyond its front contour.

Thus, in the mounted state, the HUPD 1 is placed flat along the underside of the arced helmet peak 11, without the HUPD 1 impairing the protective function (impact protection, glare shield) of the helmet peak 11.

Here too, for space optimisation, the helmet shell 10, preferably an inner hard shell (10.2) of the helmet shell 10 can have a shallow recess, which is designed essentially corresponding to the shape (contour and thickness) of the base plate 3d (not shown). The base plate 3d can in particular be arranged completely in the recess, approximately flush with the helmet shell 10, without impairing the slide mechanism of the plug connection.

The rear housing wall, curved in the direction of axis Y, of the upper shell part 8 and the rear edge (rear contour) of the base plate 3d preferably have radii that correspond to the customary radii on the inside of the helmet, shell 10, in particular on the inside of the inner hard shell 10.1 of the helmet shell 10, on the front side of the bicycle helmet 4b. In any case, the HUPD 1 is designed and arranged in the mounted state in such a way that it essentially does not protrude beyond the inner side of the helmet shell 10 and therefore is at a sufficient distance from the protective padding of the bicycle helmet 4b and from the user's head.

As a result, here too, the head-up projection device 1 does not make any contact with the user's head.

The arrangement of the HUPD 1 on the underside of the helmet peak 11 of the bicycle helmet 4b allows a largely unimpeded field of view 37 for the user and also enables glasses wearers to use glasses conveniently.

FIGS. 12, 12a show the fastening of a head-up projection device 1 to a helmet peak 11 of an industrial safety helmet 4c or other technical protective helmet.

The helmet peak 11 is biaxially arced, and arranged on the front side on a helmet shell 10 of the industrial safety helmet 4c or other technical safety helmet.

The helmet shell 10 in this embodiment comprises an outer hard shell 10.1 without an inner hard shell 10.2.

Helmet shell 10 and helmet peak 11 are made of an impact-resistant material, such as plastic. On the inside of the helmet shell 10, protective padding can be provided (not shown).

In principle, the design of the housing 2 in interaction with a base plate 3d of the HUPD 1 and its arrangement and fastening on the biaxially arced helmet peak 11 of the industrial safety helmet 4c can be analogous to the embodiment according to FIG. 11 (not explicitly shown), with the result that reference can be made to the description for FIG. 11 in this regard.

The illustrations in FIGS. 12, 12a show an alternative fastening of the head-up projection device 1 to the biaxially arced helmet peak 11 of the industrial safety helmet/protective helmet 4c in a second advantageous manner of fastening.

In contrast to the design according to FIG. 11, the fastening of the head-up projection device 1 takes place above the arced helmet peak 11 of the industrial safety helmet/protective helmet 4c.

The HUPD 1 has an essentially biaxially curved housing 2 and, in further distinction to the design according to FIG. 11, a curved/arced base plate 3b, which is formed correspondingly to a contour of the front outer side of the helmet shell 10 and is fastened to the outside of helmet shell 10 of the industrial safety helmet/protective helmet 4c. The base plate 3b is fastened to the helmet shell 10 e.g. by means of an adhesive bond or screw fastening.

The biaxially curved housing 2 of the HUPD 1 can be designed and fastened analogously to the design according to FIGS. 5a, b or FIGS. 6a, b. The following description is limited only by way of example to a design analogous to FIGS. 6a, b.

The curved base plate 3b is furthermore formed correspondingly to a rear, curved housing wall, facing the base plate 3b, of the lower shell part 14 of the housing 2 of the HUPD 1.

In this embodiment, the detachable connection or the housing 2 to the base plate 3b is made preferably by means of a magnetic connection 33 analogously to the description for FIGS. 6a, b.

The helmet peak 11, depending on the placement of the HUPD 1 along the horizontal extension of the helmet peak 11, can have an opening (opening cutout Ö) through which the combiner 5 passes and for the passage of the optical beam 29. The opening cutout Ö in the helmet peak 11 is formed at least correspondingly to the size and arrangement of the combiner 5, but can also be formed somewhat wider than the width of the combiner 5, so that the housing 2 can be arranged in the direction of the spatial axis X at an offset to the base plate 3b and thus enable a degree of freedom in the lateral positioning of the combiner 5 in the opening cutout Ö and thus in front of the eye 46 (See FIG. 12a).

The front housing wall, arced in the direction of the spatial axis Y, of the shell part 14 and the lower housing wall, arced in the direction of the spatial axis 5, of the shell part 14 or rather of the housing cover 15, have radii that correspond to the customary radii of the helmet peak 11 of the industrial safety helmet/protective helmet 4c, in such a way that the HUPD 1 essentially lies flush on the upper side of the helmet peak 11 and does not protrude beyond its front contour.

The protective function (impact protection, glare shield) of the helmet peak 11 is thus not impaired by the HUPD 1.

The rear housing wall, arced in the direction of the axis Y, of the shell part 14 and the equally arced base plate 3b preferably have radii that correspond to the customary radii of the outside of the helmet shell 10 on the front side of the industrial safety helmet/protective helmet 4c.

The arrangement of the HUPD 1 on the upper side of the helmet peak 11 of the industrial safety helmet/protective helmet 4c allows a largely unimpeded field of view 37 for the user and, of course, also enables an unimpeded use of glasses.

It is generally the case that the head-up projection device 1 according to the invention can furthermore also be used e.g. in ski helmets, sports hats/caps, full-visor protective helmets worn by firefighters or police officers, or on other protective helmets and protective hats.

The arrangement of the head-up projection device on or in the helmet shell 10 in the region of the front side of the helmet 4a, b, c leaves the functionality of the helmet 4a, b, c largely unaffected—both in respect of the homologation function (conformity with safety regulations) and in respect of the comfort function (no field of view restriction, use of shields, visors, glasses possible).

Especially in the case of motorcycle or bicycle helmets 4a, 4b, the arrangement of the head-up projection device 1 on or in the helmet shell 10 in the region of the front side furthermore minimises interference with the aerodynamics and aeroacoustics of the helmet 4a, 4b.

The housing parts 2, 7, 8, 14, 15 and where applicable the base plate 3a, b, c of the HUPD 1 can be made of plastic individually, partially or as a whole.

It is conceivable to form certain parts, sections or regions of the curved housing 2 and where applicable of the base plate 3a, b, c from particularly elastic material, such as silicone, in order to be able to make the housing 2 and the base plate 3a, b, c even more flexible and adaptable to the mounting situation and geometry of various helmets (protective helmets) 4.

The curved housing 2 can have an articulation of mechanical nature or of material nature, with e.g an elastic intermediate part. An articulation, for example in approximately the middle of the longitudinal extension of the curved housing 2 enables a bending of the curved housing 2 and therefore a reduction or extension of the radius of curvature of the curved housing 2 in adaptation to different radii of the various helmet shells 10.

FIG. 13 shows a sectional isometric view of a section of the curved housing 2 of the head-up projection device 1 according to FIGS. 5a, b in a view of the underside of the housing 2 (lower cover part 7).

The view according to FIG. 13 illustrates the fastening means for the movable fastening of the combiner 5 on the lower housing part or housing cover (lower cover part 7) in detail.

The fastening means have a pivot arm 40 rotatable mounted to the housing 2 (lower cover part 7), to which the combiner 5 is fastened. The axis of rotation 41 of the pivot arm 40 is preferably arranged essentially in the direction of the spatial axis X, in such a way that the combiner 5 can pivot approximately about the X-axis.

The combiner 5 can alternatively be movably attached by means of a two-part hinge, as described in FIGS. 14, 14a, b, or by means of a ball joint (not shown).

The alternative fastening means described above for the movable fastening of the combiner 5 can in each case interact with an adjustment mechanism.

The adjustment mechanism serves to specifically adjust the inclination/position of the combiner 5 with respect to the housing 2 and thus adjust the beam angle of the optical beam 29 from the optical module 20, in order to be able to optimally direct the optical beam 29 to the user's eye 46 (see FIGS. 18, 19).

The adjustment mechanism, as shown in FIG. 13, can be of a multi-step locking design by means of a positioning member joined to the pivot arm 40 or formed on the pivot arm 40, which engages in a corresponding toothed profile.

However, the adjustment mechanism can alternatively be designed to be steplessly adjustable, by means of a frictional connection between pivot arm 40 or rather positioning member of the pivot arm 40 and a friction partner fixed to the housing.

Thus the adjustment mechanism fixes the inclination position of the combiner 5 in such a way that it does not move out of its preset position even in the event of vibrations caused by the movement or rather by the ride of the user.

FIGS. 14, 14a, b illustrate the alternative fastening and adjustment mechanism for the movable fastening of the combiner 5 to the lower shell part 14 of the curved housing 2 of the head-up projection device according to FIGS. 6a, b.

The fastening means comprise a combiner holder 42 with a first rotary bearing element 43a extending essentially in the direction of the spatial axis X, where the combiner holder 42 can be detachably fastened to or in a housing wall of the lower shell part 14, e.g. preferably by a snap-fit element on the housing wall of the lower shell part 14 for snapping the combiner holder 42 into place.

The relevant housing wall of the lower shell part 14 has a second rotary bearing element 43b extending in the direction of the spatial axis X and corresponding to the first rotary bearing element 43a of the combiner holder 42. Both rotary bearing elements 43a, b form a two-part rotary bearing 43, in which a correspondingly formed, corresponding bearing axis of the combiner 5 is mounted, in such a way that the combiner 5 is held and arranged rotatably about an axis of rotation 41, where the location of the axis of rotation 41 preferably corresponds approximately to the direction of the spatial axis X.

As a result, the combiner holder 42 as well as the combiner 5 itself are easily accessible and replaceable for maintenance and repair purposes.

By means of a clamping piece made of silicone within the rotary bearing 43, which follows the outer contour of the bearing axis of the combiner 5 and the inner contour of the rotary bearing 43 (not shown), in the design according to FIG. 14 a frictional connection between the rotary bearing 43 and bearing axis of the combiner 5 and thus a steplessly adjustable adjustment mechanism is formed. A stiction is thereby generated in such a way that the vibrations to be expected during the use of the HUPD 1 are absorbed by the elastic clamping piece without leading to any movement in the preset inclination angle of the combiner 5.

An adjustment mechanism by means of a frictionally engaged ball joint (not shown) furthermore enables a multi-axis, stepless adjustment of the position of the combiner 5 relative to the housing 2 and therefore additional degrees of freedom in the positioning of the combiner 5.

All of the adjustment mechanisms described above enable a convenient fine adjustment of the position of the combiner 5 and thus of the generated virtual image 13 for the user.

The respective adjustment mechanism can be electronically controlled by means of an actuated electric servo motor for a further increase in convenience.

The mountings (pivot arm 40, combiner holder 42) of the combiner 5 are each formed at the edge of the flip-out combiner 5 and are designed to be particularly slim, with the remaining parts of the fastening means and the adjustment mechanism being arranged in an integrated manner within the housing 2.

As a result, only the combiner 5 of the head-up projection device 1 is arranged directly in front of the user's eye 46, where the combiner 5, which is designed to be fully transparent, does not impede the user's view.

The combiner 5 can in particular be made of transparent polycarbonate, which reduces the risk of injury to the user because of the stable and non-splintering properties of the material.

The side of the combiner 5 facing the eye 46 can have a, preferably 25%, reflective coating, which despite transparency realises such a sufficient reflective property of the combiner 5 for reflection/deflection of the light beam 29 that the light beam 29 can be imaged on the retina of the eye 46 with high image quality.

The side of the combiner 5 facing away from the eye 46 can have an anti-reflection coating/absorption coating, which prevents a double reflection/double mirroring and thus avoids the risk of generating images offset from each other.

Furthermore, this anti-reflection coating also prevents a possible disturbing reflection of light on the combiner 5 in the flipped-in state.

The optical beam 29 projected by the optical module 20 in the housing 2 onto the combiner 5 and directed into the user's eye 46 generates a virtual image 13 on the retina of the eye 46, which appears to be in the horizontal and vertical field of view 37a, b of the user (FIGS. 15, 16).

With appropriate arrangement of the optics of the optical module 20 and/or alignment of the combiner 5, the virtual image 13 can be generated in such a way in relation to the user's horizontal and vertical field of view 37a, b that the virtual image 13 occupies in each case only a narrow sector of the horizontal and vertical field of view 37a, b. This narrow sector (image sector 44) reserved for the virtual image 13 can, for the purpose of keeping free certain critical regions of the field of view 37, such as the field of view 37 of the traffic ahead and/or the oncoming traffic, be angularly offset, preferably with an offset angle of 5° to 10° in each case, laterally to the right or left and/or vertically upwards or downwards, with respect to the straight viewing axis 45 (see FIGS. 15, 16).

FIG. 15 shows a usual vertical field of view 37b (FoV) of the user and, provided by way of example, a vertical image sector 44b (field with bold outline), where in this example the inclination of the combiner 5 about an X-axis is adjusted in such a way that the vertical image sector 44b is slightly shifted upwards, with an offset angle of approximately 5°, out of the straight viewing axis 45 of the eye (dash-dotted line).

FIG. 16 shows a usual horizontal field of view 37a (FoV) of the user with, provided by way of example, a horizontal image sector 44a (field with bold outline), where the optics of the optical module 20 and the combiner 5 are arranged relative to each other in such a way that the horizontal image sector 44a is slightly shifted to the right, with an offset angle of approximately 10°, out of the straight viewing axis 45 of the eye (dash-dotted line).

This arrangement of the viewing sector 44a, b according to FIGS. 15 and 16 is particularly advantageous for a motorcyclist user who is driving in right-hand traffic.

For the motorcyclist user who is driving in left-hand traffic, by means of the alignment of the optics of the optical module 20 and the combiner 5, the horizontal image sector 44a for example can be shifted to the left, with an offset angle of approximately 10°, out of the straight viewing axis 45 of the eye (dash-dotted line).

This alignment of the virtual image 13 or rather of the image sector 44a, b can be realised on the one hand by means of a corresponding arrangement and alignment of the combiner 5 in relation to the prism 26 standing at the end of the optical module 20.

A vertical offset of the virtual image 13 or rather of the image sector 44b can be achieved for example by means of the combiner 5, which is rotationally adjustable about the X-axis, as shown in FIGS. 13 and 14, and can be adjusted as desired.

It is furthermore conceivable to generate an arbitrarily adjustable, horizontal offset of the virtual image 13 or rather of the image sector 44a for example by means of a combines 5 that is rotationally adjustable about the Z-axis.

FIG. 17 shows a schematic representation of an arrangement of the optical module 20 within the housing 2 of the head-up device 1 according to FIGS. 2.1a to 4.1c, 5a, b in a relationship to the expected position of the user's eyes 46, with which a horizontal offset of the virtual image 13 or rather of the image sector 44a can be predetermined by means of the device. The example shows the generation of a horizontal offset of the virtual image 13 or rather of the image sector 44a with an offset angle α of approximately 10° to the right of the straight viewing axis 45 of the right eye 46 of the user. For the sake of clarity, the helmet 4 on which the head-up device 1 is arranged in this case is not shown.

The layout of the envisaged position of the optical module 20, in particular the position of the prism 26 standing at the end (and thus also that of the combiner 5) is based on the one hand on an average interpupillary distance (eye distance D_{A}) of 65 mm among various people as determined in scientific studies, and on the other hand on an average pupil position within in a stray field 47 (eyebox 47).

In this embodiment, the head-up device 1 is designed and arranged on the helmet 4 in relation to the user's eyes 46 in such a way that a centre axis (reference axis) 48 of the housing 2 of the head-up device 1, which in this example corresponds to the axis of symmetry of the housing 2, is positioned centrally between the eyes 46 and thus approximately congruently with half the average eye distance D_{A}. The correct positioning of the head-up device 1 or rather of the centre axis (reference axis) 48 of the housing 2 in relation to the helmet 4 or rather to the eyes 46 can be facilitated by a suitable marker M on the housing 2, which e.g. marks the centre axis (reference axis) 48.

The prism 26 standing at the end of the optical module 20 is offset to the right of the centre axis (reference axis) 48 of the housing 2 of the head-up device 1 to such an extent that the light beam 29 emerging from the exit surface of the prism 26 and deflected on the combiner 5 strikes the right eye 46 at an offset angle α of approximately 10° to the right of the straight viewing angle 45 within the eyebox 47, in order to achieve a corresponding offset angle of the virtual image 13 or rather of the image sector 44a relative to the straight viewing axis 45.

In this case, the centre of the reflection surface of the prism 26 is arranged offset by approximately 32.5 mm (half of the average eye distance D_{A}) plus a further offset length L_{V45}, which results from the angular relationship of the offset angle α to the distance E_{R} of the right eye 46 from the prism 26 (centre of the reflection surface of the prism 26), horizontally and at right angles to the centre axis (reference axis) 48 of the housing 2 of the head-up device 1. (The offset length L_{V45} of the light beam 29 at the centre of the reflection surface of the prism 26 with respect to the straight viewing axis 45 is calculated using the distance E_{R} multiplied by the sine of the offset angle α: L_{V}=E_{R}×sin α).

Assuming that the centre axis (reference axis) 48 of the head-up device 1 is positioned centrally to the eye position (half eye distance ½D_{A}) and the distance E_{R} of the right eye 46 from the prism 26 (centre of the reflection surface of the prism 26) is preferably approx. 35 mm, the total horizontal offset of the centre of the prism 26 with respect to the centre axis (reference axis) 48 of the housing 2 of the head-up device 1 works out to be approximately L_{V48}=38.6 (32.5+6.1) mm (offset length L_{V48} of the light beam 29 at the centre of the reflection surface of the prism 26 with respect to the centre axis (reference axis) 48).

FIG. 17a shows the schematic representation of the arrangement of the optical module 20 within the housing 2 of the head-up device 1 according to FIGS. 2.2a to 4.2c, 6a, b in a relationship to the position of the user's eyes 46, in order likewise to realise a horizontal offset of the virtual image 13 or rather of the image sector 44a with an offset angle α of approximately 10° to the right of the straight viewing axis 45 of the right eve 46 of the user in accordance with the design shown in FIG. 17.

In contrast to the design according to FIG. 17, the head-up device 1 in this embodiment designed and arranged on the helmet 4 in relation to the eyes 46 or rather to the right eye 46 of the user in such a way that a predetermined reference axis 48 of the asymmetrical housing 2b of the head-up device 1 is positioned approximately congruently with the half eye distance D_{A} (centrally between the eyes 46).

In this embodiment, the location of the reference axis 48 of the housing 2b does not correspond to half the housing length due to the lack of an axis of symmetry and must be determined separately.

The location of the reference axis 48 of the housing 2b in relation to the optical module 20 is determined by the horizontal offset length L_{V48}, which, starting from the centre of the reflection surface of the prism 26 is calculated using the imaginary half eye distance D_{A} plus the offset length L_{V45} of the centre of the reflection surface of the prism 26 with respect to the straight viewing axis 45 of the right eye 46. The offset length L_{V45}, to achieve an offset angle α of the virtual image 13 or rather of the image sector 44a of approximately 10° from the straight viewing axis 45 is calculated according to the description for FIG. 17, to which reference is made.

The correct positioning of the head-up device 1 or rather of the reference axis 48 of the housing 2b in relation to the helmet 4 or rather to the eves 46 can be facilitated by a suitable marker M on the housing 2, which e.g. marks the determined reference axis 48.

To realise the straight optical axis 28 in the curved housing 2, the length of the optical path 29 from the exit of the light beam 29 from the image source (display) 23 to the exit of the light beam 29 from the prism 26 within the optical module 20 can be made particularly short through a corresponding design of the optics. Thus, as well as the convex lens 25, the achromat 24 can additionally be designed to magnify the image to be projected which comes out of the image source 23.

Also, instead of an achromat 24 and/or a convex lens 25 with a typically round circumference, to save space an achromat 24 and/or a convex lens 25 with polygonal circumference or with different circumferential radii over the circumference can be formed (see FIGS. 5b, 6b).

The optical elements 23, 24, 25, 26 of the optical module 20 and the combiner 5 are arranged relative to each other in such a way that the light beam 29 or rather the optical path 29 is deflected twice (black, thick line in the side view of the optical module 20 according to FIG. 18 and in the 90° rotated view of the optical module 20 according to FIG. 19).

The first deflection of the optical path 29, by approximately 90°, takes place at the end of the optical module 20 on the reflective plane/slanted face of the prism 26 in the direction of the combiner 5 arranged thereunder (FIG. 18).

The second deflection of the optical path 29, by again approximately 90°, takes place in one direction of the eye 46 as a result of the particular arrangement of the reflective combiner 5 in relation to the prism 26 (FIG. 19).

Here, the plane of the combiner 5 is rotated by 90° relative to the reflective plane/slanted face of the prism 26 and additionally arranged inclined by approximately 45° with respect to the exit plane/surface of the prism 26 (FIGS. 18, 19).

By means of the above-mentioned designs, the advantageous arrangement of the head-up projection device 1 with a horizontally extending optical module 20 in the forehead region of the head above the eyes 46 or rather in the front region of the helmet 4 above the eyes 46 and thus outside the user's field of view 37 can be realised, while a virtual image generation can be realised directly in front of the user's eye 46.

As the image source 23, preferably a space-, weight- and energy-saving OLED display 23 is used. In this way, on the one hand the necessary size and weight of the battery(-ies) 22 carried in the curved housing 2 can be reduced, which improves the wearing comfort of the head-up projection device 1.

In addition, the use of an OLED display 23 enables a space-saving reduction of the screen diagonal of the image source 23, preferably to a screen diagonal of the display 23 of approx. 0.19″ (approx. 0.483 cm).

As a result, the paraxial region of the optics becomes narrower, which enables a smaller diameter of the subsequent optical elements (achromat 24, convex lens 25, prism 26) of the optical module 20, i.e. the optical module 20 is slimmer as a result and can be arranged even better inside the curved housing 2 of the head-up projection device 1.

The small screen diagonal of the display 23 requires a greater magnification, which for example can be produced by a smaller radius and consequently a greater thickness of the optical elements (achromat 24, convex lens 25), where as a result of the associated lower focal length, the distance between the optical elements (achromat 24, convex lens 25) and between them and the image source 23 can be smaller, in such a way that ultimately the installation space or rather the total installation space length of the optical module 20 can be smaller.

Preferably an OLED display 23 is used which emits monochromatic yellow light, in a wavelength of approx. 564 nm and/or with a luminous intensity of 12,000 cd/m², better still of 20,000 cd/m², particularly preferably of 25,000 cd/m². This light produces a very high luminance of the OLED display 23, which realises a strong, low-loss optical beam through the optical elements and subsequently a virtual image of high sharpness and brightness.

However, it is just as advantageous to use a multicoloured OLED display 23.

The optics or rather the optical path 29 of the optical module 20 is designed in such a way that a virtual image 13 can be generated in apparent size and distance, which allows a relaxing view for the user and does not require focusing alternately between close and distant vision. In this respect, such a design of the optics proves to be particularly favourable for the user's eye, with which design a virtual image 13 with an apparent screen image diagonal of 90″ (228.60 cm) and an apparent distance of more than 3 m, preferably approximately 10 m (optical infinity) is generated. In this constellation, the images to be captured by the eye (real image and virtual image 13) are largely balanced with each other in respect of their distance and are therefore less tiring.

To realise the favourable virtual image 13, the optics or rather the optical path 29 of the optical module 20 is designed in corresponding coordination of the materials and radii of the achromat 24 and of the convex lens 25 and thus in a certain magnification/focal length of the achromat 24 and of the convex lens 25 in relation to the distance/to the distances between the display 23 and the achromat 24 and between the achromat 24 and the convex lens 25.

The optics or rather the optical path 29 of the optical module 20 for generating an advantageous virtual image 13 with an apparent image diagonal of 90″ (228.60 cm) and at an apparent distance of approximately 10 m can be formed starting from an OLED display 23 with a screen diagonal of 0.19″ (4.83 mm) for example according to the following illustration:

In this embodiment, the material of the achromat 24, of the single convex lens, 25 and of the prism 26 consist of fine annealed glass with the following material designations:
Biconcave lens of the achromat 24: SF6
Biconvex lens of the achromat 24: N-LAK8
Single convex lens 25: N-BK7
Prism 26: N-BK7.

According to this embodiment, the advantageous virtual image 13 is achieved with a length of the optical path 29 of only 43.22 mm from the exit of the light beam 29 out of the image source (OLED display) 23 to the entry of the light beam 29 into the prism 26.

The total installed length of the optical module 20 from the image source 23 (display) to the prism 26 including the surrounding multi-part optics casing 27 is here only 49.15 mm.

The stated dimensions are design values, to which the practical implementation of the optical module 20 is approximated as far as possible.

By varying the distance between display 23 and achromat 24, the apparent distance can be varied. With the distance shown of 11.4979 mm, an apparent distance of the virtual image 13 of approximately 10 m is achieved. However, when the distance between display 23 and achromat 24 is changed, the distance between achromat and convex lens 25 must remain the same in order for the image to continue to appear sharp.

Alternatively, the material of the achromat 24, of the single convex lens 25 and of the prism 26 can consist of fine annealed glass with the following material designations:
Biconcave lens of the achromat 24: H-ZF7LA.
Biconvex lens of the achromat 24: H-LAK7A
Single convex lens 25: H-K9L
Prism 26: N-BK7.

With these materials of the optical elements 24, 25, 26, a low-cost optical module 20 can be provided, with which the quality of the image reproduction of the virtual image 13 can be ensured to a still sufficient degree, i.e. without disadvantageously limiting the image quality for the user.

On the circuit board 21, which is also located in the housing 2 of the head-up projection device 1, essentially all the necessary electronic components of the head-up projection device 1 are arranged, such as microprocessor/microcontroller, data storage, data interface, an inertial measurement unit (9 DoF IMU—9 Degrees of Freedom Inertial Measurement Unit) with several inertial sensors, such as 3-axis acceleration sensor, 3-axis position sensor (gyroscope) and 3-axis magnetometer (compass), and further electronic components, such as the light and brightness sensor 32.

The block diagram in FIG. 20 shows the functional scheme of the head-up projection device 1 in which the functional interrelationships of all components in the housing 2 of the head-up projection device 1 are shown.

The microprocessor/microcontroller controls all processes and evaluates the acquired data. In particular, the image source 23 (display) is controlled by the processor.

The microprocessor/microcontroller, via the data interface, acquires and processes data from different external host systems (central data processing systems), and furthermore data from the integrated inertial measurement unit and from the integrated sensors.

The data interface is used for wireless data exchange with at least one host system (preferably smartphone) via a wireless communication system such as Bluetooth or Wi-Fi. In addition, wireless data exchange with several other host systems (vehicle/motorcycle electronics, smartwatch, wearables, headset, video camera etc.) is possible.

The data interface receives all data not provided by the integrated sensors (e.g. speed, navigation instructions, time, notifications, warning messages and other information etc. from the host systems).

The inertial measurement unit is intended among other things for the geographical positioning of the head-up projection device 1 and thus of the helmet 4, E.g. from the acquisition of acceleration values and the direction of travel via the position sensor, an improved speed display compared to GPS is available, including when passing through tunnels.

Possibly, through corresponding head movement, by means of the position sensor, via the microprocessor/microcontroller, a differentiated control of the head-up projection device 1 can take place.

The compass can be used to support off-road navigation.

By means of the right and brightness sensor 32, the brightness of the display 23 can be controlled via the processor, in particular an automatic dimming of the brightness of the display 23 and thus an adaptation of the brightness of the virtual image 13 to the ambient conditions (e.g. when entering or exiting tunnels, changing between day/night mode etc.) can take place.

The battery(/-ies) 22 serve to supply power for the operation of the microcontroller, the inertial measurement unit, the image source 23, the light sensor and the communication system (Bluetooth, Wi-Fi) at different voltage levels. Preferably, lithium-ion batteries 22 are used, which because of their favourable power-to-size ratio and low weight can be arranged space-savingly and without significantly weighing down the head-up projection device 1 in the housing 2 of the head-up projection device 1, which further improves the wearing comfort of the head-up projection device 1. The batteries 22 can be charged via a connectable external power supply unit, with a usual charging protection circuit protecting the lithium-ion batteries 22 from destruction or catching fire.

These and further features arising from the patent claims, the description of the example embodiments and the drawings can in each case be realised by themselves or combination as advantageous embodiments of the invention for which protection is claimed here.

The term “and/or” used here, when used in a series of two or more elements, means that any of the listed elements may be used alone, or any combination of two or more of the listed elements may be used. For example, if a relationship is described that contains the components A, B and/or C, the relationship can contain the component A alone; B alone; C alone; A and B in combination; A and C in combination; B and C in combination; or A, B and C in combination.

### LIST OF REFERENCE NUMERALS

1 Head-up projection device (HUPD)
2 Housing of the HUPD symmetrical a, asymmetrical b
3 Base plate of the HUPD flat, crescent-shaped a, curved strip-shaped b, curved tray-shaped c, curved, crescent-shaped d
4 Helmet, protective helmet, motorcycle helmet a, bicycle helmet b, industrial safety helmet c
5 Combiner
6 Power supply socket
7 Lower, flat housing part, lower cover part
8 Upper shell-shaped housing part, upper shell part
9 Housing wall of the upper shell part
10 Helmet shell, outer hard shell .1, inner hard shell .2
11 Helmet peak
12 Opening in the lower cover part, opening in the lower shell part
13 Virtual image
14 Lower, shell shaped housing part, lower shell part
15 Upper, flat housing part, upper cover part
16 Retaining pins
17 Opening in the lower shell part
18 Switch, push-button
19 Recess, positioning pocket of the base plate
20 Optical module
21 Electronics module, circuit board
22 Battery
23 Optical element, image source, display
24 Optical element, achromat
25 Optical element, convex lens
26 Optical element, prism
27 Optics housing, optics casing, casing element a, b, c
28 Optical axis
29 Light beam, optical path of the light beam
30 Railed guidance
31 Snap part
32 Light and brightness sensor
33 (Permanent) magnet
34 (Permanent) opposing magnet
35 Knob′, knob receptacle″
36 Circumferential rim, positioning pocket of the upper cover part
37 Field of view, horizontal a, vertical b
38 Viewing window of the helmet shell
39 Visor, full visor
40 Pivot arm
41 Axis of rotation
42 Combiner holder
43 Two-part rotary bearing, first, second rotary bearing element a, b
44 Image sector, horizontal a, vertical b
45 Straight viewing axis
46 Eye
47 Eyebox
48 Centre axis/reference axis of the housing of the HUPD
A Recess in the helmet shell
Ö Opening cutout in the helmet peak
α Offset angle
D_{A} Average distance between the eyes (eye distance)
E_{R} Distance of the right eye from the prism
L_{V74} Offset length of the prism with respect to the straight viewing axis 45 of the eye
L_{V48} Offset length of the prism with respect to the centre axis 48 of the housing
M Marker

1.-22. (canceled)

23. A head-up projection device, wherein the device is configured for arrangement on or in a helmet, for acquiring and processing data and for reproducing the data in a virtual image within a field of view of an eye of a user of the helmet, the head-up projection device comprising a housing in which operating elements for acquiring and processing data and for imaging reproduction of the data are arranged, and a combiner disc arranged on the housing, the housing being longitudinally extended and having a curved geometry such that the housing is arrangeable substantially in a front region of the helmet above the eye(s) of the user and the combiner disc is positionable in front of the user's eye.

24. The device of claim 23, wherein the housing is longitudinally extended along a spatial axis X and is curved in a direction of a spatial axis Y.

25. The device of claim 23, wherein the housing is curved in a direction of a spatial axis Z.

26. The device of claim 23, wherein the combiner disc is movably mounted on the housing.

27. The device of claim 23, wherein the operating elements arranged in the housing comprise at least one optical module with optical elements, a processor with control electronics for controlling the optical module, and an accumulator.

28. The device of claim 23, wherein the housing comprises several parts.

29. The device of claim 27, wherein the optical elements of the optical module are arranged in an optics housing.

30. The device of claim 27, wherein the housing and/or the operating elements are configured and arranged such that an optical axis realized by the optical elements extends essentially in a direction of a spatial axis X along which the housing longitudinally extends.

31. The device of claim 23, wherein an image source is provided, which comprises OLEDs.

32. The device of claim 31, wherein the OLEDs emit monochromatic light.

33. The device of claim 31, wherein the OLEDs have a luminous intensity of 12,000 cd/m² to 20,000 cd/m².

34. The device of claim 23, wherein the device comprises fastening elements for a direct, detachable fastening of the housing on or in the helmet, the fastening elements comprising a base plate which is formed correspondingly to the geometry of the housing and is detachably connectable to the housing.

35. The device of claim 34, wherein the fastening elements comprise connecting elements of a hook-and-loop fastener connection, plug connection or magnetic connection.

36. The device of claim 35, wherein the connecting elements are formed and arranged such that an arrangement of the housing in relation to the base plate is laterally displaceable essentially in a direction of a spatial axis X along which the housing longitudinally extends.

37. The device of claim 23, wherein the device comprises adjustment elements for adjusting and fixing a position of the combiner disc relative to the housing.

38. The device of claim 37, wherein the adjustment elements comprise a pivot arm engaging in a toothed profile.

39. The device of claim 37, wherein the adjustment elements comprise a clamping piece arranged in a rotary bearing.

40. A helmet, wherein the helmet is configured for arranging the head-up projection device of claim 23 on or in the helmet.

41. The helmet of claim 40, wherein the helmet is configured for an integrated arrangement of at least a part of the head-up projection device on or in the helmet.

42. The helmet of claim 40, wherein a helmet shell of the helmet comprises a recess, in which the housing of the head-up projection device and/or a base plate of fastening elements for a direct, detachable fastening of the housing on or in the helmet is at least partially arrangeable.
